(19) United States
(12) Patent Application Publication
(10) Pub. No.: US 2009/0271336 A1
(43) Pub. Date: Oct. 29, 2009

(54) Environmentally-friendly fitness center systems

(76) Inventor: Travis Dean Franks, Phoenix, AZ (US)

Correspondence Address: Travis Frank, Suite 540, 10851 N Black Canyon Highway, Phoenix, AZ, 85029, US

(21) Appl. No.: 12/378,804

(22) Filed: Feb. 18, 2009

Related U.S. Application Data
(60) Provisional application No. 61/029,547, filed on Feb. 18, 2008.

(51) Int. Cl. G06Q 90/00; H02K 7/18; F99Z 99/00

(52) U.S. Cl. 705/500; 290/1 A

(57) ABSTRACT

This invention provides an environmentally-friendly system for operating a green fitness facility. It also provides for the use of a human-powered renewably energy source in a fitness facility. It further provides for the monetization of surplus power generated, carbon-credits earned through its operation method, and the promotion of an ecologically-minded fitness center.

### CROSS-REFERENCE TO RELATED APPLICATION

The present application is related to prior provisional application Ser. No. 61/029,547, filed 18 Feb. 2008, entitled “ECOLOGICAL FITNESS SYSTEMS”, the contents of which are incorporated herein by this reference and is not admitted to be prior art with respect to the present invention by the mention in this cross-reference section.

### BACKGROUND

The present invention relates to environmentally-friendly fitness center systems. More particularly, this invention relates to a system providing an environmentally responsible exercise facility. Even more particularly, this invention relates to a ready system for providing environmentally-friendly fitness centers which: collect and recycle energy generated by human exercising; are housed in low-resource consumption facilities; and utilize low carbon-footprint operating methods. Further, this invention relates to providing and operating electrical-grid-connected exercise equipment, and to selling of surplus power, generated from human exercising and other renewable energy sources, to an electrical utility company.

Also, importantly, this invention relates to providing a ready system for encouraging users of such environmentally-friendly fitness centers to track their individual contributions to both the energy self-sufficiency and reduced carbon-footprint of such environmentally-friendly fitness centers. Additionally, this invention relates to a ready system for encouraging users of such environmentally-friendly fitness centers to achieve group-goals of energy self-sufficiency and/or reduced carbon-footprint of such environmentally-friendly fitness centers. Also this invention relates to achieving such group goals by providing for at least one competitive event between or among a plurality of such environmentally-friendly fitness centers.

Presently, fitness centers do not comprise a system for generating electrical power using a plurality of human-exercising machines and other renewable energy sources to power such fitness centers or to sell to an electrical utility company. Instead, fitness centers for humans are presently large consumers of power and resources and have little regard for the environment in which they reside. The power consumed by such fitness centers contributes to atmospheric pollutants throughout the carbon chain. This contribution leaves a carbon footprint which has a negative effect on our ecosystem. Individuals who attend such facilities do not even consider “working out” to be a way in which they may help the environment.

Thus, a need exists for an environmentally-friendly fitness center system that unites its users with a strong sense of pride in doing an environmentally-responsible act and promotes a safer, cleaner environment in which to exercise and live.

### OBJECTS AND FEATURES OF THE INVENTION

A primary object and feature of the present invention is to provide a system overcoming the above-mentioned problems.

A further primary object and feature of the present invention is to provide such a system which uses renewable energy sources as its primary power. It is a further primary object and feature of the present invention to provide such a system which generates, on-site, the power needed for the operation of a fitness center, particularly, using the energy expended during an exercise to produce that power. Another primary object and feature of the present invention is to provide a ready system for providing environmentally-friendly fitness centers for collecting and recycling renewable energy generated by human exercising. Even more importantly, it is a primary object and feature of the present invention to provide a system which defines and/or provides electrical-grid connected exercise equipment. It is further object of future of the present invention to provide such a system which provides a fitness center which uses excess renewable energy generated on-site as a source of income by selling such excess renewable energy to electrical utility companies.

It is a further primary object and feature of the present invention to provide such a system which provides for the use of environmentally-friendly products and services, in a fitness center, to reduce the carbon footprint of that fitness center. Even further, another primary object and feature of the present invention is to house such a fitness center in low-resource consumption facilities and utilizing low carbon-footprint operating methods. It is a further object of feature of the present invention to provide such a system which uses a locally accepted environmentally-friendly standard in building, operating, and/or renovating such a fitness center facility. And further, it is a primary object and feature of the present invention to provide such a system which provides for such a fitness center facility to be certified in such a locally accepted environmentally-friendly standard. It is a further primary object and feature of the present invention to provide such a system which uses such reduction of the carbon footprint of a fitness center as a source of income, by selling earned carbon credits through a carbon credit aggregator.

It is a further primary object and feature of the present invention to provide such a system which encourages members of a fitness center to contribute to the saving of the environment. It is a further primary object and feature of the present invention to provide a ready system for encouraging users of such environmentally-friendly fitness centers to track their individual contributions to the energy self-sufficiency and/or reduced carbon-footprint of such environmentally-friendly fitness centers. Additionally, it is a further primary object and feature of the present invention to provide a ready system for encouraging users of such ecologically-minded human-fitness centers to achieve group level goals of energy self-sufficiency and/or reduced carbon-footprint of such environmentally-friendly fitness centers by providing for competitive events between or among a plurality of such environmentally-friendly fitness centers.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a method comprising the steps of: operating at least one exercise facility; generating electrical power locally at such at least one exercise facility; wherein such step of generating electrical power comprises the steps of converting human kinetic energy into electrical power, and generating electrical power using at least one other-than-human renewable energy source; and using such generated electrical power to assist in powering such at least one exercise facility.

Moreover, it provides such a method wherein such at least one other-than-human renewable energy source comprises solar energy. Additionally, it provides such a method wherein such at least one other-than-human renewable energy source comprises wind energy. Also, it provides such a method wherein such at least one other-than-human renewable energy source comprises geothermal energy. In addition, it provides such a method wherein such at least one other-than-human renewable energy source comprises tidal energy. And, it provides such a method wherein such at least one other-than-human renewable energy source comprises hydroelectric energy. Further, it provides such a method further comprising the step of selling such generated electrical power to at least one electrical utility company.

Even further, it provides such a method wherein such step of operating at least one exercise facility comprises the step of purposefully instituting at least one carbon-footprint reduction method. Moreover, it provides such a method wherein such at least one carbon-footprint reduction method comprises planting and maintaining vegetation. Additionally, it provides such a method wherein such at least one carbon-footprint reduction method comprises recycling. Also, it provides such a method wherein such at least one carbon-footprint reduction method comprises recycling grey water. In addition, it provides such a method wherein such at least one carbon-footprint reduction method comprises recycling rain water.

And, it provides such a method wherein such at least one carbon-footprint reduction method comprises the step of reducing electrical energy consumption. Further, it provides such a method wherein such step of reducing electrical energy consumption comprises the step of using solar energy to heat water for use in at least one swimming pool. Even further, it provides such a method wherein such step of reducing electrical energy consumption comprises the step of using solar energy to heat water for use as hot tap water.

Moreover, it provides such a method wherein such step of reducing electrical energy consumption comprises the step of using natural lighting. Additionally, it provides such a method wherein such step of reducing electrical energy consumption comprises the step of using energy-efficient lighting. Also, it provides such a method wherein such step of reducing electrical energy consumption comprises the step of using additional insulation to reduce atmospheric-temperature-control electrical energy consumption. In addition, it provides such a method wherein such additional insulation comprises recycled materials.

And, it provides such a method wherein such at least one carbon-footprint reduction method comprises the step of using at least one atmospheric contaminant reduction method. Further, it provides such a method wherein at least one atmospheric contaminant reduction method comprises the step of using electrostatic air filtration. Even further, it provides such a method wherein at least one atmospheric contaminant reduction method comprises the step of using at least one low-emission paint.

Moreover, it provides such a method wherein such at least one carbon-footprint reduction, method comprises the step of complying with at least one locally-recognized environmentally-friendly building code. Additionally, it provides such a method wherein such at least one locally-recognized environmentally-friendly building code comprises LEED Green Building Rating System.

Also, it provides such a method further comprising the step of storing such generated electrical power in at least one local storage device, when such generated electrical power exceeds such used generated electrical power. In addition, it provides such a method wherein such at least one local storage device comprises at least one battery. And, it provides such a method wherein such at least one local storage device comprises at least one hydrogen energy storage method. Further, it provides such a method wherein such at least one hydrogen energy storage method comprises the steps of: disassociating hydrogen gas in water in at least one electrolysis chamber; and storing disassociated hydrogen gas in at least one hydrogen storage tank. Even further, it provides such a method further comprising the step of retrieving such stored electrical power using at least one hydrogen fuel cell.

Moreover, it provides such a method further comprising the step of obtaining at least one carbon credit due to such step of purposefully instituting at least one carbon-footprint reduction method. Additionally, it provides such a method further comprising the step of monetizing such at least one carbon credit through at least one carbon-credit aggregator.

In accordance with another preferred embodiment hereof, this invention provides an exercise facility comprising: at least one local electrical power generator structured and arranged to generate electrical power locally at such exercise facility; wherein such at least one local electrical power generator comprises at least one human kinetic energy converter structured and arranged to convert human kinetic energy into electrical power; and wherein such at least one local electrical power generator further comprises at least one renewable energy generator structured and arranged to generate electrical power using at least one other-than-human renewable energy source; and exercise-facility electrical power user structured and arranged to use such generated electrical power assisting in powering such exercise facility.

Also, it provides such an exercising facility wherein exercising facility is certified by at least one locally-recognized environmentally-friendly building code. In addition, it provides such an exercising facility wherein such at least one locally-recognized environmentally-friendly building code comprises LEED Green Building Rating System. And, it provides such an exercising facility wherein such at least one other-than-human renewable energy source comprises solar energy. Further, it provides such an exercising facility wherein such at least one other-than-human renewable energy source comprises wind energy. Even further, it provides such an exercising facility wherein such at least one other-than-human renewable energy source comprises geothermal energy. Moreover, it provides such an exercising facility wherein such at least one other-than-human renewable energy source comprises tidal energy. Additionally, it provides such an exercising facility wherein such at least one other-than-human renewable energy source comprises hydroelectric energy.

Also, it provides such an exercising facility further comprising at least one local storage device structured and arranged to store electrical power, when such generated electrical power exceeds such used generated electrical power. In addition, it provides such an exercising facility wherein such at least one local storage device comprises at least one battery. And, it provides such an exercising facility wherein such at least one local storage device comprises at least one hydrogen energy storage system.

Further, it provides such an exercising facility wherein such at least one hydrogen energy storage system comprises: at least one hydrogen gas disassociator structured and arranged to disassociate hydrogen gas from water; and at least one hydrogen gas storer structured and arranged to store such disassociated hydrogen gas. Even further, it provides such an exercising facility wherein such at least one hydrogen gas disassociator comprises at least one electrolysis chamber. Moreover, it provides such an exercising facility wherein such at least one hydrogen gas storer comprises at least one hydrogen storage tank. Additionally, it provides such an exercising facility wherein such at least one hydrogen energy storage system further comprising at least one electrical power retriever structured and arranged to retrieve such stored electrical power from such hydrogen gas. Also, it provides such an exercising facility wherein such at least one electrical power retriever comprises at least one hydrogen fuel cell.

In accordance with another preferred embodiment hereof, this invention provides a method comprising the steps of: franchising at least one environmentally-friendly fitness center business method; wherein such at least one environmentally-friendly fitness center business method comprises the step of operating at least one exercise facility; wherein such at least one environmentally-friendly fitness center business method further comprises at least one carbon-credit monetizing method; and at least one environmentally-friendly power monetizing method; wherein such at least one carbon-credit monetizing method comprises the steps of purposefully instituting at least one carbon-footprint reduction method; obtaining at least one carbon credit due to such step of purposefully instituting at least one carbon-footprint reduction method; and monetizing such at least one carbon credit through at least one carbon-credit aggregator; and wherein such at least one environmentally-friendly power monetizing method comprises the steps of generating electrical power locally at such at least one exercise facility; and selling such generated electrical power to at least one electrical utility company.

In addition, it provides such a method wherein such at least one environmentally-friendly fitness center business method comprising the steps of: wherein such step of generating electrical power comprises the steps of converting human kinetic energy into electrical power, and generating electrical power using at least one other-than-human renewable energy source; and using such generated electrical power to assist in powering such at least one exercise facility. And, it provides such a method wherein such at least one other-than-human renewable energy source comprises solar energy. Further, it provides such a method wherein such at least one other-than-human renewable energy source comprises wind energy. Even further, it provides such a method wherein such at least one other-than-human renewable energy source comprises geothermal energy. Moreover, it provides such a method wherein such at least one other-than-human renewable energy source comprises tidal energy. Additionally, it provides such a method wherein such at least one other-than-human renewable energy source comprises hydroelectric energy.

Also, it provides such a method wherein such at least one carbon-footprint reduction method comprises planting and maintaining vegetation. In addition, it provides such a method wherein such at least one carbon-footprint reduction method comprises recycling. And, it provides such a method wherein such at least one carbon-footprint reduction method comprises recycling grey water. Further, it provides such a method wherein such at least one carbon-footprint reduction method comprises recycling rain water.

Even further, it provides such a method wherein such at least one carbon-footprint reduction method comprises the step of reducing electrical energy consumption. Moreover, it provides such a method wherein such step of reducing electrical energy consumption comprises the step of using solar energy to heat water for use in at least one swimming pool. Additionally, it provides such a method wherein such step of reducing electrical energy consumption comprises the step of using solar energy to heat water for use as hot tap water.

Also, it provides such a method wherein such step of reducing electrical energy consumption comprises the step of using natural lighting. In addition, it provides such a method wherein such step of reducing electrical energy consumption comprises the step of using energy-efficient lighting. And, it provides such a method wherein such step of reducing electrical energy consumption comprises the step of using additional insulation to reduce atmospheric-temperature-control electrical energy consumption. Further, it provides such a method wherein such additional insulation comprises recycled materials.

Even further, it provides such a method wherein such at least one carbon-footprint reduction method comprises the step of using at least one atmospheric contaminant reduction method. Even further, it provides such a method wherein at least one atmospheric contaminant reduction method comprises the step of using electrostatic air filtration. Even further, it provides such a method wherein at least one atmospheric contaminant reduction method comprises the step of using at least one low-emission paint.

Even further, it provides such a method wherein such at least one carbon-footprint reduction method comprises the step of complying with at least one locally-recognized environmentally-friendly building code. Even further, it provides such a method wherein such at least one locally-recognized environmentally-friendly building code comprises LEED Green Building Rating System.

Even further, it provides such a method further comprising the step of storing such generated electrical power in at least one local storage device, when such generated electrical power exceeds such used generated electrical power. Even further, it provides such a method wherein such at least one local storage device comprises at least one battery. Even further, it provides such a method wherein such at least one local storage device comprises at least one hydrogen energy storage method. Even further, it provides such a method wherein such at least one hydrogen energy storage method comprises the steps of: disassociating hydrogen gas in water in at least one electrolysis chamber; and storing disassociated hydrogen gas in at least one hydrogen storage tank. Even further, it provides such a method further comprising the step of retrieving such stored electrical power using at least one hydrogen fuel cell.

In accordance with another preferred embodiment hereof, this invention provides an exercise facility comprising: local electrical power generator means for generating electrical power locally at such exercise facility; wherein such local electrical power generator means comprises human kinetic energy converter means for converting human kinetic energy into electrical power; and wherein such local electrical power generator means further comprises renewable energy generator means for generating electrical power using at least one other-than-human renewable energy source; and exercise-facility electrical power user means for using such generated electrical power to assist in powering such exercise facility. Even further, it provides each and every novel feature, element, combination, step and/or method disclosed or suggested by this patent application.

### BRIEF DESCRIPTION OF THE DRAWINGS

FIG. 1 shows a diagram overview of at least one preferred environmentally-friendly fitness center system, illustrating the preferred incorporation of at least one preferred environmentally-friendly subsystem into at least one preferred environmentally-friendly fitness center business system, according to a preferred embodiment of the present invention.

FIG. 2 shows a diagram overview of at least one preferred powering system, illustrating the use of renewable energy to power at least one preferred environmentally-friendly fitness center, according to the preferred embodiment of FIG. 1.

FIG. 3 shows a diagram overview of at least one preferred operations system, illustrating implementation of at least one preferred carbon-footprint reduction technology in the operation of such preferred environmentally-friendly fitness center, according to a preferred embodiment of FIG. 1.

FIG. 4 shows a diagram of such at least one preferred powering system, illustrating supply of preferred electrical power to operate such preferred environmentally-friendly fitness center, according to the preferred embodiment of FIG. 1.

FIG. 5 shows a diagram of at least one carbon chain, illustrating associated elements of a carbon footprint, according to the preferred embodiment in FIG. 1.

FIG. 6 shows a diagram of at least one preferred operations system, illustrating the interaction between such at least one carbon chain and such preferred environmentally-friendly fitness center, according to the preferred embodiment of FIG. 1.

FIG. 7A shows a diagram of a preferred environmentally-friendly fitness center business system, illustrating at least one preferred business relationship associated with such preferred environmentally-friendly fitness center system, according to the preferred embodiment FIG. 1.

FIG. 7B shows a diagram of preferred licensee/licensor business relationship, illustrating at least one preferred support service made available to preferred corporate entity, according to the preferred embodiment of FIG. 1.

FIG. 8 shows a schematic block diagram of a preferred data-communication architecture, illustrating preferred data exchange and preferred processing of such preferred environmentally-friendly fitness center system, according to the preferred embodiment of FIG. 1.

FIG. 9 shows a schematic block diagram view, of a typical hardware environment for an implementation of such preferred environmentally-friendly fitness center business system for such preferred environmentally-friendly fitness center system, according to the preferred embodiment of FIG. 1.

Appendix A illustrates/discusses preferred environmentally-friendly fitness center system business method concepts.

Appendix B illustrates/discusses preferred environmentally-friendly fitness center infrastructure concepts.

Appendix C illustrates/discusses preferred environmentally-friendly fitness center system equipment details.

### DETAILED DESCRIPTION OF THE BEST MODES AND PREFERRED EMBODIMENTS OF THE INVENTION

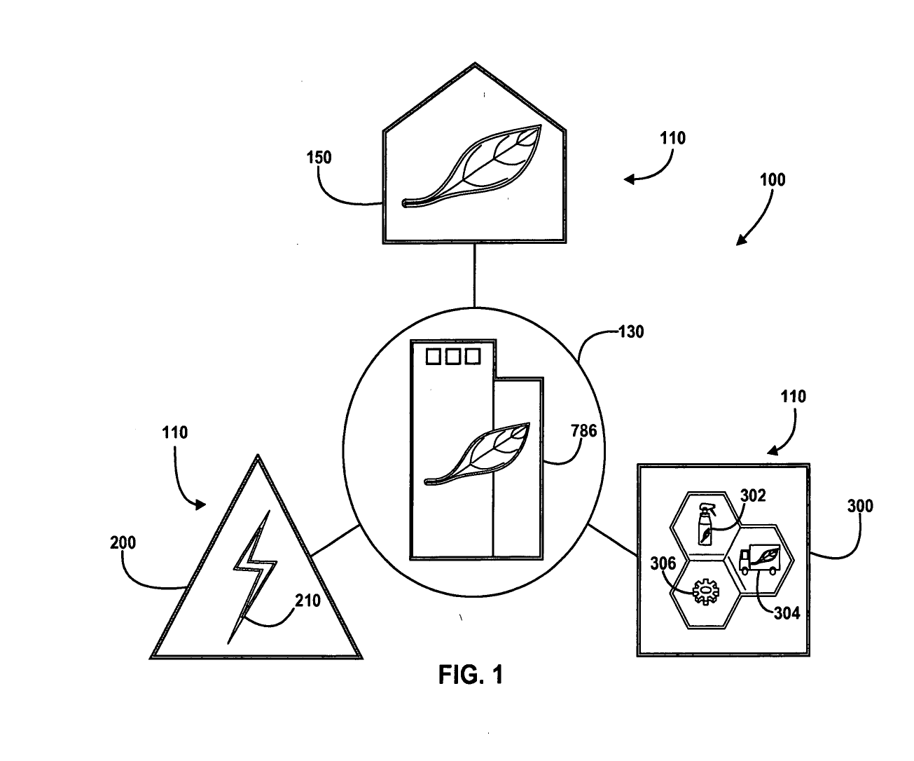

FIG. 1 shows a diagram overview of at least one environmentally-friendly fitness center system 100, illustrating the incorporation of at least one environmentally-friendly subsystem 110 into at least one environmentally-friendly fitness center business system 130, according to a preferred embodiment of the present invention, as shown. Environmentally-friendly fitness center system 100 preferably comprises environmentally-friendly fitness center business system 130, as shown. Environmentally-friendly fitness center business system 130 preferably provides at least one environmentally-friendly fitness center 786, as shown, which preferably has a reduced impact on the environment, as compared to a traditional fitness center. To reduce such impact on the environment, environmentally-friendly fitness center business system 130 preferably comprises environmentally-friendly subsystem 110, as shown.

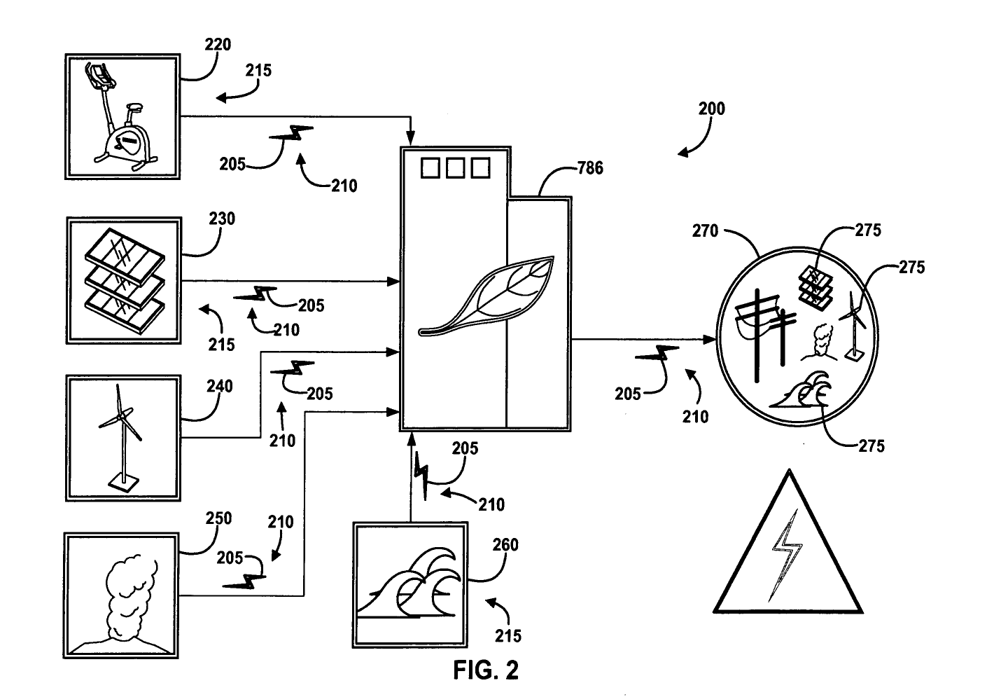

One such environmentally-friendly subsystem 110 preferably comprises at least one powering system 200, as shown. Powering system 200 preferably provides renewable energy 210, which preferably has a lower impact on the environment, preferably for powering environmentally-friendly fitness center 786 (see discussion of FIG. 2). Powering system 200 preferably comprises generating renewable energy 210 on-site at environmentally-friendly fitness center 786, alternately preferably obtaining renewable energy 210 from at least one electrical utility company 270, as shown in FIG. 2. By using powering system 200, environmentally-friendly fitness center 786 preferably has a reduced environmental impact.

Another such environmentally-friendly subsystem 110 preferably comprises at least one operations system 300. Operations system 300 preferably employs at least one environmentally-friendly product 302, as shown, which preferably is made in an environmentally-friendly manner, alternately preferably uses recycled materials, alternately preferably presents little to no environmentally-damaging content. Operations system 300 preferably further employs at least one environmentally-friendly service 304, as shown, from at least one third party, which preferably is conducted in an environmentally-friendly manner. Operations system 300 alternately preferably uses environmentally friendly product 302. Even further, operations system 300 preferably employs, to conduct day-to-day business, at least one environmentally-friendly procedure 306, as shown, which preferably reduces electricity consumption, alternately preferably promotes environmental health. By using operations system 300, environmentally-friendly fitness center 786 comprises preferably increased energy efficiency and preferably lowered environmental impact.

Yet another such environmentally-friendly subsystem 110 preferably comprises at least one fitness facility 150, as shown. Fitness facility 150 preferably employs methods outlined by preferably at least one locally-recognized environmentally-friendly building code, preferably the LEED (Leadership in Energy and Environmental Design) Green Building Rating System directed by the U.S. Green Building Council. This arrangement at least embodies herein wherein such at least one carbon-footprint reduction method comprises the step of complying with at least one locally-recognized environmentally-friendly building code; and this arrangement at least embodies herein wherein such at least one locally-recognized environmentally-friendly building code comprises LEED Green Building Rating System. By complying with LEED, fitness facility 150 preferably comprises increased energy efficiency and lowered environmental impact. Upon reading this specification, those skilled in the art will now appreciate that, under appropriate circumstances, considering such issues as locality, future technologies, local laws, etc., other locally-recognized environmentally-friendly building codes, such as, for example, Building Research Establishment Environmental Assessment Method (BREEAM), city-established environmentally-friendly building codes, other nationally-established environmentally-friendly building codes, etc., may suffice.

FIG. 2 shows a diagram overview of powering system 200, illustrating sources of renewable energy 210 to power environmentally-friendly fitness center 786, according to the preferred embodiment of FIG. 1. Renewable energy 210 preferably comprises electrical power 205. To reduce environmental impact, renewable energy 210, in the form of electrical power 205, preferably powers environmentally-friendly fitness center 786, as shown. Appropriate to the location of environmentally-friendly fitness center 786, powering system 200 preferably employs at least one renewable energy source 275, as shown, to obtain renewable energy 210 preferably for powering environmentally-friendly fitness center 786.

Renewable energy source 275 preferably comprises, as shown, at least one on-site energy source 215 of renewable energy 210, alternately preferably utility company 270 that supplies renewable energy 210. When electrical power 205 from on-site energy source 215 is insufficient to fully power environmentally-friendly fitness center 786, additional electrical power 205 may preferably be obtained from utility company 270, as shown. Electrical power 205 supplied by utility company 270 preferably comprises renewable energy 210, as shown. When on-site energy source 215 generates a surplus of electrical power 205, such surplus of electrical power 205 may preferably be sent to utility company 270, as shown.

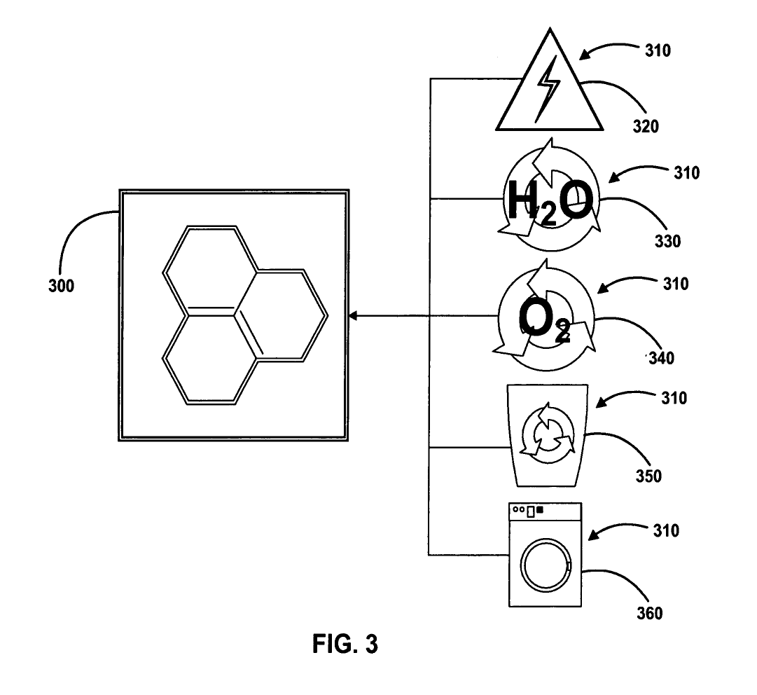

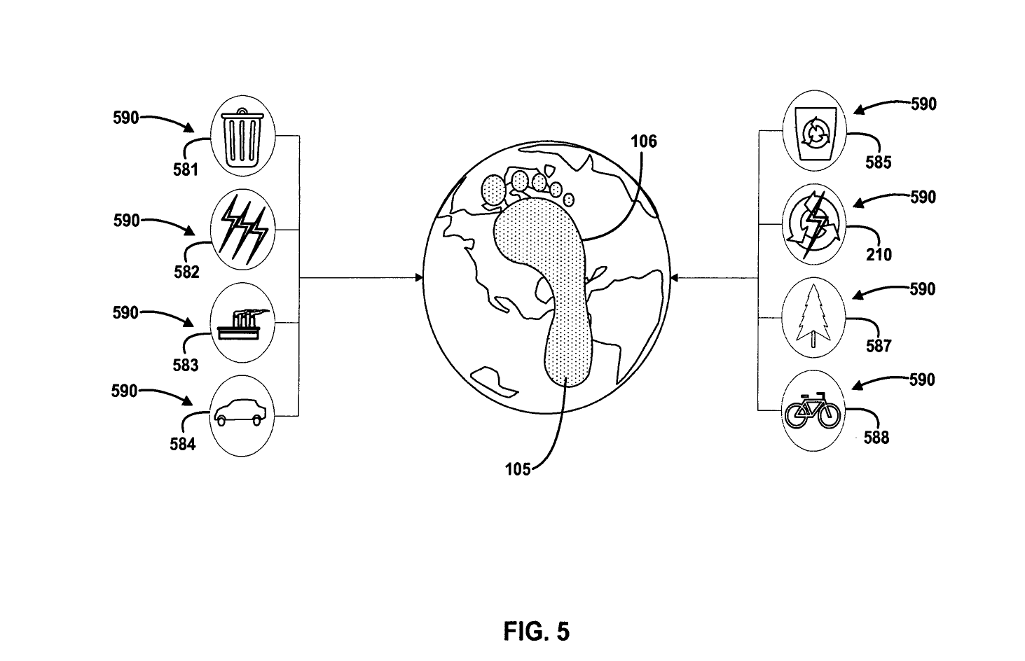

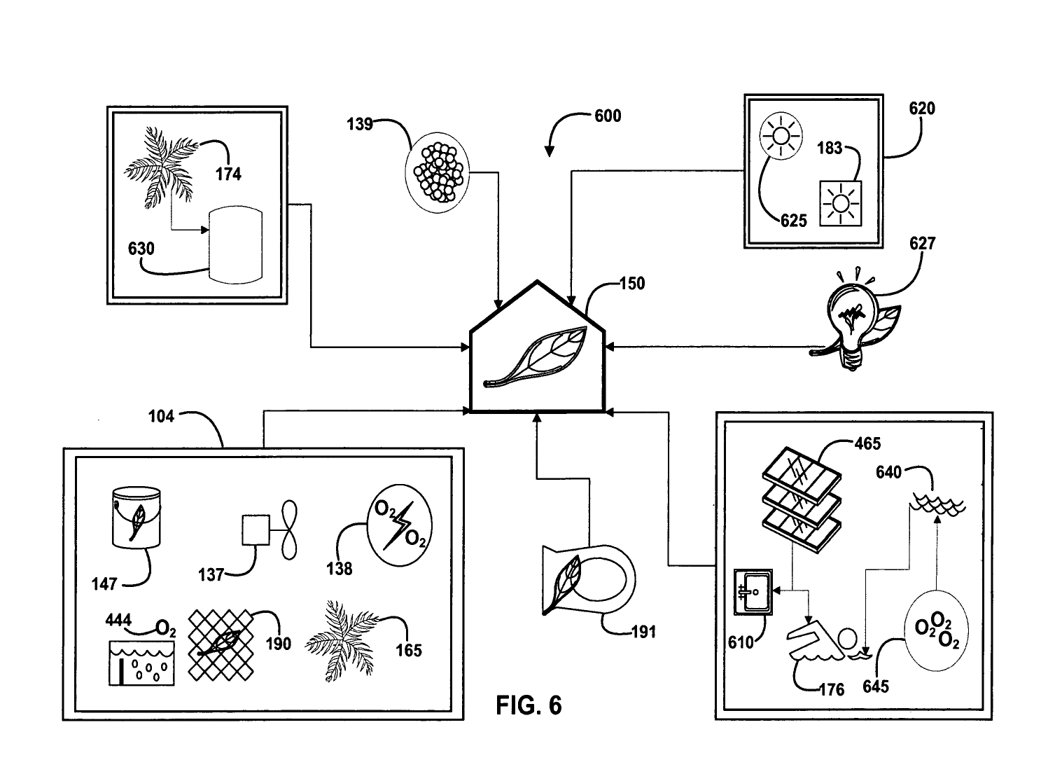

FIG. 3 shows a diagram overview of operations system 300, illustrating implementation of at least one carbon-footprint reduction technology 310 in operation of environmentally-friendly fitness center 786, according to a preferred embodiment of FIG. 1. Operations system 300 preferably employs carbon-footprint reduction technology 310, preferably to reduce direct and indirect emissions of greenhouse gases 105 (see discussion of FIG. 5) from the operation of environmentally-friendly fitness center 786. Carbon-footprint reduction technology 310 comprises preferably energy efficiency 320 of renewable energy 210, alternately preferably efficient water use 330, alternately preferably air rehabilitation 340, alternately preferably low carbon-footprint consumable materials 350, alternately preferably low carbon-footprint durable materials 360, as shown (see discussion of FIG. 6 for greater detail). This arrangement at least embodies herein wherein such step of operating at least one exercise facility comprises the step of purposefully instituting at least one carbon-footprint reduction method.

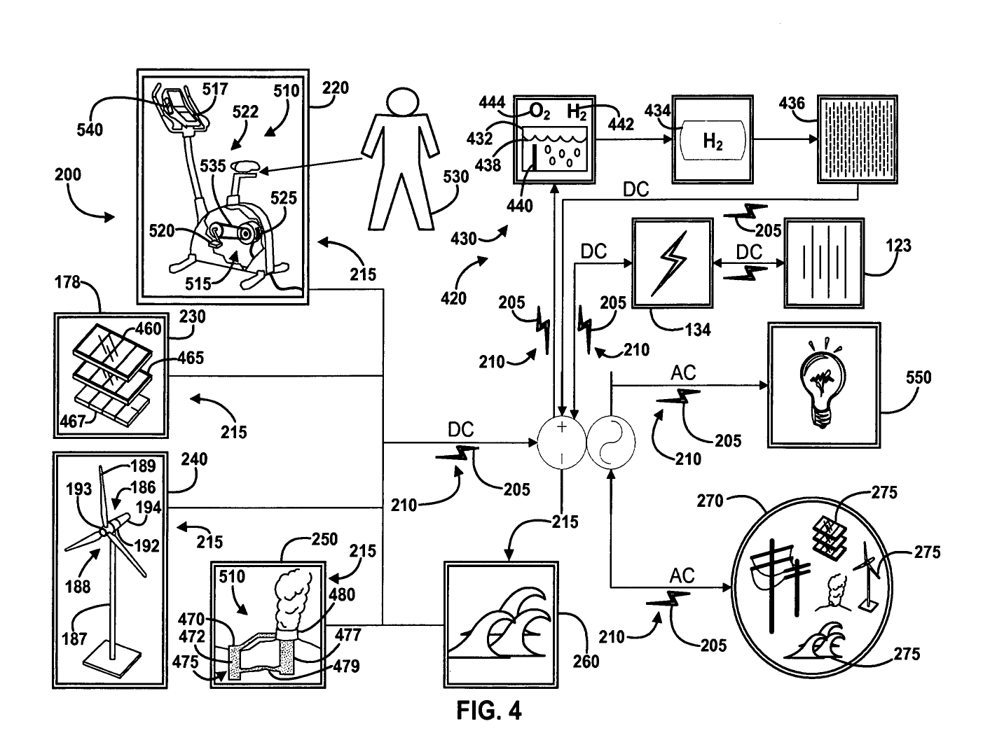

FIG. 4 shows a diagram of powering system 200, illustrating supply of electrical power 205 to operate environmentally-friendly fitness center 786, according to the preferred embodiment of FIG. 1. Powering system 200 (at least embodying herein generating electrical power locally at such at least one exercise facility) preferably comprises at least one building power grid 550, as shown. Building power grid 550 preferably supplies electrical power 205 from on-site energy source 215 to environmentally-friendly fitness center 786, as shown (at least embodying herein using such generated electrical power to assist in powering such at least one exercise facility). Building power grid 550 is preferably also connected to utility company 270, as shown, so that electrical power 205 may be exchanged with utility company 270. To store surplus power from on-site energy source 215, building power grid 550 preferably connects, as shown, to at least one building-energy storage device 420 (at least embodying herein at least one local storage device structured and arranged to store electrical power, when such generated electrical power exceeds such used generated electrical power), preferably at least one local battery bank 123, alternately preferably at least one hydrogen-energy storage system 430. Upon reading this specification, those skilled in the art will now appreciate that, under appropriate circumstances, considering such issues as future technologies, cost, etc., other building-energy storage devices, such as, for example, water reservoirs, chemical mixtures, vertically displaced weights, springs, etc., may suffice.

Local battery bank 123 comprises preferably a plurality of floating type batteries, alternately preferably a plurality of deep-cycle type batteries. Upon reading this specification, those skilled in the art will now appreciate that, under appropriate circumstances, considering such issues as future battery types, wiring configurations, available materials, technological advances, etc., other battery types such as, for example, wet-cell batteries, dry-cell batteries, lithium-ion batteries, etc., may suffice. Local battery bank 123 is preferably kept within a reasonable operating temperature range of preferably between about −40 degrees Fahrenheit and about 150 degrees Fahrenheit preferably to maintain maximum efficiency. Local battery bank 123 is preferably kept out of direct sunlight, preferably within a shading structure, preferably allowing adequate ventilation. Local battery bank 123 preferably may be hooked in series and/or parallel depending on application demands. Local battery bank 123 is preferably connected to building power grid 550 through at least one voltage regulator 134, as shown. Voltage regulator 134 is preferably used for charging local battery bank 123 and preferably draining electrical power 205 from local battery bank 123.

When used in charging local battery bank 123, voltage regulator 134 preferably provides local battery bank 123 with the correct voltage and current preferably to optimize charging of local battery bank 123. When used in drawing electrical power 205 from local battery bank 123, voltage regulator 134 preferably drains electrical power 205 at a steady rate preferably to extend longevity and efficiency of local battery bank 123. Voltage regulator 134 preferably uses at least one electromechanical mechanism, alternately preferably at least one passive electronic component, alternately preferably at least one active electronic component. Voltage regulator 134 preferably may be used to regulate one or more sources of electrical power 205. Voltage regulator 134 preferably compares actual output voltage to an internal fixed reference voltage, preferably allowing local battery bank 123 to be charged and drained at an even rate preferably for longevity and efficiency of local battery bank 123 (at least embodying herein wherein such at least one local storage device comprises at least one battery).

Hydrogen-energy storage system 430 preferably comprises a method to store energy in the form of hydrogen gas preferably for later use (this arrangement at least embodying herein wherein such at least one local storage device comprises at least one hydrogen energy storage method). Hydrogen-energy storage system 430 (at least embodying herein wherein such at least one local storage device comprises at least one hydrogen energy storage system) preferably comprises at least one electrolysis chamber 432, at least one hydrogen storage tank 434, and at least one hydrogen fuel cell 436, as shown.

Electrolysis chamber 432 preferably connects to building power grid 550, as shown, so that surplus electrical power 205 may be stored in hydrogen-energy storage system 430. Electrolysis chamber 432 (at least embodying herein at least one hydrogen gas disassociator structured and arranged to disassociate hydrogen gas from water; and at least embodying herein wherein said at least one hydrogen gas disassociator comprises at least one electrolysis chamber) preferably contains distilled water 438 and preferably at least one electrode 440, as shown. When surplus electrical power 205 is available, electrode 440 preferably uses electrical power 205 to disassociate distilled water 438 preferably creating hydrogen 442 and oxygen 444 (this arrangement at least embodying herein disassociating hydrogen gas in water in at least one electrolysis chamber). Upon reading this specification, those skilled in the art will now appreciate that, under appropriate circumstances, considering such issues as future technologies, cost, etc., other methods of disassociating hydrogen from water, such as, for example, chemical reactions, sonic vibrations, etc., may suffice.

Hydrogen 442 is preferably collected and preferably stored in hydrogen storage tank 434 (at least embodying herein storing disassociated hydrogen gas in at least one hydrogen storage tank; and at least embodying herein at least one hydrogen gas storer structured and arranged to store such disassociated hydrogen gas; and at least embodying herein wherein such at least one hydrogen gas storer comprises at least one hydrogen storage tank), as shown, while oxygen 444 is preferably allowed to enrich the environment of environmentally-friendly fitness center 786, as shown in FIG. 6. Upon reading this specification, those skilled in the art will now appreciate that, under appropriate circumstances, considering such issues as future technologies, cost, etc., other methods of storing hydrogen, such as, for example, chemical reactions, metal hydrides, etc., may suffice.

When electrical power 205 is needed, hydrogen fuel cell 436 preferably uses hydrogen 442 stored in hydrogen storage tank 434 preferably to produce electrical power 205, as shown (this arrangement at least embodying herein retrieving such stored electrical power using at least one hydrogen fuel cell). Hydrogen fuel cell 436 (at least embodying herein wherein said at least one hydrogen energy storage system further comprises at least one electrical power retriever structured and arranged to retrieve such stored electrical power from such hydrogen gas; and at least embodying herein wherein said at least one electrical power retriever comprises at least one hydrogen fuel cell) preferably feeds electrical power 205 to building power grid 550, as shown. Upon reading this specification, those skilled in the art will now appreciate that, under appropriate circumstances, considering such issues as future technologies, cost, etc., other methods of retrieving electrical power from hydrogen from water, such as, for example, chemical reactions, sonic vibrations, etc., may suffice.

Electrical power 205 generated by on-site source 215 comprises direct current power (DC), as shown, which fluctuates as on-site energy source 215 generates more and less power. In order to be useful, direct current power (DC) is conditioned preferably to minimize spikes and preferably to equalize flow of power to at least one consistent level. Conditioning is preferably performed using at least one power conditioning inverter 410, as shown. After conditioning, electrical power 205 may be stored in at least one building-energy storage device 420, as shown. (This arrangement at least embodies herein storing such generated electrical powering in at least one local storage device, when such generated electrical power exceeds such used generated electrical power). Additionally, to use electrical power 205 from building-energy storage device 420, power conditioning inverter 410 preferably provides connectivity between building power grid 550 and building-energy storage device 420, as shown.

Power conditioning inverter 410, preferably in addition to conditioning, preferably changes direct current (DC) into alternating current (AC), as shown. Since building power grid 550 operates using alternating current (AC), power conditioning inverter 410 preferably provides connectivity, as shown, between building power grid 550 and on-site energy source 215. Alternating current (AC) supplied by power conditioning inverter 410 is preferably compatible to electrical power 205 supplied by utility company 270, preferably facilitating the exchange of alternating current (AC) from power conditioning inverter 410 and utility company 270. Building-energy storage device 420 also provides electrical power 205, in the form of direct current (DC), preferably to power conditioning inverter 410 for inversion into alternating current (AC) preferably before used in building power grid 550 (at least embodying herein exercise-facility electrical power user structured and arranged to use such generated electrical power assisting in powering said exercise facility), as shown.

On-site source 215 (at least embodying herein at least one local electrical power generator structured and arranged to generate electrical power locally at said exercise facility) of renewable energy 210 preferably comprises at least one human-generated energy source 220, alternately preferably at least one solar energy source 230, alternately preferably at least one wind energy source 240, alternately preferably at least one geothermal energy source 250 (at least embodying herein wherein such at least one other-than-human renewable energy source comprises geothermal energy), alternately preferably at least one water movement energy source 260. (This arrangement at least embodying herein generating electrical power using at least one other-than-human renewable energy source; and this arrangement at least embodying herein wherein said at least one local electrical power generator further comprises at least one renewable energy generator structured and arranged to generate electrical power using at least one other-than-human renewable energy source.) Upon reading this specification, those skilled in the art will now appreciate that, under appropriate circumstances, considering such issues as available renewable energy sources, available technologies, etc., other renewable energy sources, such as, for example, biodiesel, heat transfer, gravitational, etc., may suffice.

Human generated energy source 220 (at least embodying herein converting human kinetic energy into electrical power) preferably comprises at least one piece of exercise equipment 510, as shown. During fitness activities, at least one patron 530 preferably expends energy which is preferably converted into electrical power 205 by exercise equipment 510, as shown. Exercise equipment 510 preferably comprises at least one energy converter 515 used to convert kinetic energy, of at least one patron 530 performing at least one fitness activity, into electrical power 205. Energy converter 515 preferably comprises at least one generator 525, as shown. Exercise equipment 510 further comprises preferably at least one battery 540 and preferably at least one instrumentation panel 517, as shown. Instrumentation panel 517 preferably uses energy stored in battery 540 to operate. Electrical power 205, converted by energy converter 515, preferably charges battery 540. When battery 540 is fully charged, surplus electrical power 205 is preferably transferred to at least one building power grid 550, as shown.

Exercise equipment 510 preferably comprises at least one exercise bike 522, as shown, alternately preferably at least one treadmill (not shown), alternately preferably at least one stair climber (not shown). Upon reading this specification, those skilled in the art will now appreciate that, under appropriate circumstances, considering such issues as exercise trends, available exercise equipment, new technologies, etc., other exercise equipment, such as, for example, skiing machines, rowing machines, weightlifting devices, etc., may suffice. Exercise equipment 510 (at least embodying herein wherein said at least one local electrical power generator comprises at least one human kinetic energy converter structured and arranged to convert human kinetic energy into electrical power) preferably comprises at least one user-manipulated moving part, preferably at least one rotationally moving part, preferably at least one pedal 520, as shown. Upon reading this specification, those skilled in the art will now appreciate that, under appropriate circumstances, considering such issues as exercise equipment, cost, future technologies, etc., other moving parts, such as, for example, wheels, rods, gears, cables, etc., may suffice. Pedal 520 attaches to energy converter 515, preferably using at least one motion transferring device. Such at least one motion transferring device comprises preferably at least one belt 535, as shown, alternately preferably at least one chain, not shown, alternately preferably at least one gear, also not shown. Energy converter 515 preferably uses motion transferred by belt 535 to generate electrical power 205. Upon reading this specification, those skilled in the art will now appreciate that, under appropriate circumstances, considering such issues as available technologies, cost, kinematics, etc., other motion transferring devices, such as, for example, axles, magnetic fields, rods, etc., may suffice.

Solar energy source 230 (at least embodying herein wherein such at least one other-than-human renewable energy source comprises solar energy) comprises preferably at least one solar panel 178. Solar panel 178 preferably comprises at least one photovoltaic panel 460, alternately preferably at least one solar heating panel 465, alternately preferably at least one photovoltaic shingle 467, as shown. Upon reading this specification, those skilled in the art will now appreciate that, under appropriate circumstances, considering such issues as available technologies, cost, efficiency, etc., other solar energy sources, such as, for example, solar energy paint, photovoltaic films, etc., may suffice.

Preferably, solar energy is used by photovoltaic panel 460 preferably to produce electrical power 205, as direct current power (DC), using the photoelectric effect. Photovoltaic shingle 467 likewise converts solar energy preferably into electrical power 205 using the photoelectric effect. Solar energy is used by solar heating panel 465 to heat water preferably for use in at least one steam generator thereby producing electrical power 205. Solar panel 178 is preferably mounted to the roof of fitness facility 150, preferably south facing. Photovoltaic shingle 467 mounts to the roof of fitness facility 150 preferably in place of at least one ordinary roofing shingle. Solar panel 178 is preferably kept within a temperature range of between −40 degrees Fahrenheit and 185 degrees Fahrenheit to maintain maximum efficiency. This may be accomplished preferably by using the angle of orientation for solar panel 178, alternately preferably by providing cooling, preferably by passing a fluid such as air or liquid through or around solar panel 178.

Winds are created when turbulent masses of air rush to equalize differences in atmospheric pressure, created by the sun heating the air in one location more than another. Therefore, energy from wind is also a form of solar energy. Wind energy source 240 preferably comprises at least one wind turbine 186, preferably at least one horizontal axis wind turbine, as shown, alternately preferably at least one vertical axis wind turbine, not shown. Upon reading this specification, those skilled in the art will now appreciate that, under appropriate circumstances, considering such issues as wind-energy conversion, available materials, technological advances, etc., other wind energy sources such as, for example, wind turbines adapted to intermittent power, vaneless ion wind generators, etc., may suffice.

Wind turbine 186 preferably generates electrical power 205 by converting the force of wind into a rotary motion of at least one electrical generator 194. When adequate wind is available, wind energy source 240 (at least embodying herein wherein such at least one other-than-human renewable energy source comprises wind energy) preferably feeds electrical power 205 into building power grid 550, as shown. Average winds speeds are preferably at least about 10 mph to ensure feasibility.

Wind turbine 186 preferably comprises, as shown, at least one main rotor shaft 193 and electrical generator 194. At least one blade 189 preferably attaches to main rotor shaft 193, as shown. Blade 189 is preferably colored light gray to blend in with the clouds for aesthetic appearances. Blade 189 preferably rotates main rotor shaft 193, preferably converting wind energy to an intermediate low-speed rotational energy. To maintain a safe operating environment, blade 189 preferably may rotate between about 10 revolutions and about 22 revolutions per minute.

Main rotor shaft 193 preferably connects to at least one gearbox 192, as shown. Gearbox 192 preferably steps up the speed from main rotor shaft 193 to the optimal turning speed for electrical generator 194. Electrical generator 194 and gearbox 192 preferably convert the low-speed rotational energy into electrical power 205. Upon reading this specification, those skilled in the art will now appreciate that, under appropriate circumstances, considering such issues as converting linear to rotational movement, available materials, technological advances, etc., other low-speed rotational energy convertors, such as, for example, cogs, cogwheels, gearwheels, pinions, rag wheels, sprockets, spur wheels to turn a driveshaft, jackshafts, set of satellite gears within a housings, worm gears, rack and pinion combinations, etc., may suffice. At least one blade 189 comprises preferably metal, alternately preferably alloyed metal, alternately preferably non-metal material.

When horizontal-axis type is used, wind turbine 186 preferably is elevated on at least one tall tower 187, as shown, preferably to allow at least one rotor 188 contact with higher velocity wind energy normally found at higher elevations. Tall tower 187 preferably ranges from about 60 meters to about 90 meters in height and blade 189 preferably ranges in length from about 20 meters to about 40 meters. The significant difference between height of tall tower 187 and length of blade 189 preferably allows the safe operation of wind turbine 186.

When horizontal-axis type is used, wind turbine 186 preferably is pointed into the wind using computer controls. Alternately preferably, at least one tail-vane may be employed for alignment into the wind. Proper alignment is preferred for maximum efficiency, since the amount of power transferred to a wind turbine is directly proportional to the density of the air, the area swept out by the rotor, and the wind speed.

Preferably, such at least one vertical-axis wind turbine, not shown, may be used preferably for space-savings for in-town constructions. Such at least one vertical-axis wind turbine may be mounted preferably on the roof of at least one fitness facility 150, alternately preferably on at least one parking garage. Upon reading this specification, those skilled in the art, will now appreciate that, under appropriate circumstances, considering such issues as facility design, future technologies, cost, safety, etc., other mounting locations, such as, for example, on a hillside, on a bluff, freestanding, etc., may suffice.

Wind turbine 186 is preferably designed to be bird-safe and quiet during operation. The quiet operation of wind turbine 186 preferably reduces noise pollution and preferably doesn't distract peaceful natural ambiance of environmentally-friendly fitness center 786 for patron 530.

When available, geothermal energy source 250 may also feed energy into building power grid 550, as shown. Geothermal energy source 250 preferably comprises at least one geothermal well 173, as shown. Geothermal energy source 250 preferably generates electrical power 205 preferably from heat stored beneath the surface of the earth and preferably is sustainable because water used in the geothermal process is preferably re-injected into the ground to gather more heat.

Geothermal well 173 preferably pumps water 472, under high pressure, down at least one borehole 470 preferably into at least one heat zone 475, as shown. Water 472 preferably travels from borehole 470 out into heat zone 475 preferably through at least one fracture 479 in the rock, as shown. This action allows water 472 preferably to escalate in temperature, adding thermal energy, preferably by capturing heat from heat zone 475 until water 472, with significantly higher temperature, is preferably forced out of at least one second borehole 477, as shown.

Heat from such water is preferably converted into electrical power 205 preferably by at least one steam turbine 480, as shown, alternately preferably at least one binary power plant system, not shown, that changes potential thermodynamic energy to kinetic energy first. Upon reading this specification, those skilled in the art will now appreciate that, under appropriate circumstances, considering such issues as electricity conversion, available materials, technological advances, etc., other thermal energy converters such as, rotary generators, Magnetohydrodynamic generators, pistons, etc., may suffice.

Water movement energy source 260 comprises preferably wave/tidal energy, alternately preferably hydroelectric energy (this arrangement at least embodying herein wherein such at least one other-than-human renewable energy source comprises tidal energy; and this arrangement at least embodying herein wherein such at least one other-than-human renewable energy source comprises hydroelectric energy). Wave energy and hydroelectric energy may be used where there is appropriate access to water. Wave energy refers to the energy of ocean surface waves captured to do useful work. Wave energy may preferably be extracted from gravity-powered tides, preferably by locating at least one water turbine in at least one tidal current. Wave energy may alternately preferably be extracted by building impoundment-pond dams that admits water, as the tide rises, and releases water, as the tide recedes, through at least one turbine. Such at least one water turbine can turn at least one electrical generator producing electrical power 205. Wave energy is used when environmentally-friendly fitness center 786 is located near at least one large body of water that experiences tidal influences. Upon reading this specification, those skilled in the art will now appreciate that, under appropriate circumstances, considering such issues as alternate energy storage means, available materials, technological advances, etc., other project parameters such as, sound wave energy, water wheels, heat storage devices, chemical storage devices, etc., may suffice.

Hydroelectric energy is a renewable energy source 275, which by using moving water, produces no waste or greenhouse gases 105. Potential energy of dammed water is preferably used for driving at least one water turbine, preferably by releasing dammed water and thereby preferably turning at least one electrical generator to produce electrical power 205. The amount of potential energy is proportional to the head. The head comprises the height difference between the source of water and the height at which the outflow exits from. During times when electricity demand is low, excess generation capacity may preferably be used to pump water into at least one higher elevated reservoir. When there is higher demand, water may be released back into at least one lower reservoir through such at least one water turbine to meet those needs. Hydroelectric energy alternately preferably comprises at least one continuous moving water source. With such at least one continuous moving water source, a waterwheel is preferably use to turn at least one electrical generator to produce electrical power 205. Waterwheel size is dependent on water source volume, velocity and amount of power required. Applications requiring steady power may use reservoir-style hydroelectric energy or such at least one continuously running waterwheel, depending on the water sources available. Upon reading this specification, those with ordinary skill in the art will now appreciate that, under appropriate circumstances, considering such issues as water source availability, available materials, technological advances, etc., other water energy converters such as disks, drums, rollers, rotational devices, spinners, other turbines etc., may suffice.

FIG. 5 shows a diagram of at least one carbon chain 102, illustrating associated elements of a carbon footprint 106, according to the preferred embodiment in FIG. 1. Choices of goods and services that inflict minimal harm on the environment may be termed “environmentally-friendly”. Within that ideal is a subset of contributing factors measured as carbon-footprint 106. Carbon-footprint 106 measures the impact human-activities have on the environment in terms of the amount of greenhouse gases 105 being produced. Emission of greenhouse gases 105 is measured in units of carbon dioxide and other similar gases. Measuring carbon-footprint 106 is a means of comparing consumption and lifestyles, as well as of tracking at least one environmental impact of such consumption and such lifestyles. Carbon-footprint 106 is based on the estimated land area and vegetation needed to recapture greenhouse gases 105 that are released by at least one consumptive process 590.

Such a measurement system preferably has purposeful meaning for patron 530. Patron 530 may conceptualize their individual and collective contributive carbon footprint 106, due to their activities and choices. Once carbon footprint 106 has been conceptualized, strategic efforts may be made towards reducing carbon footprint 106. In this regard, carbon-footprint 106 may be seen as the total amount of greenhouse gases 105 emitted over the full life-cycle of at least one product or service, leaving a lasting impression or “footprint”. Preferably, the lowering of carbon-footprint 106 increases the environmental pride of patron 530.

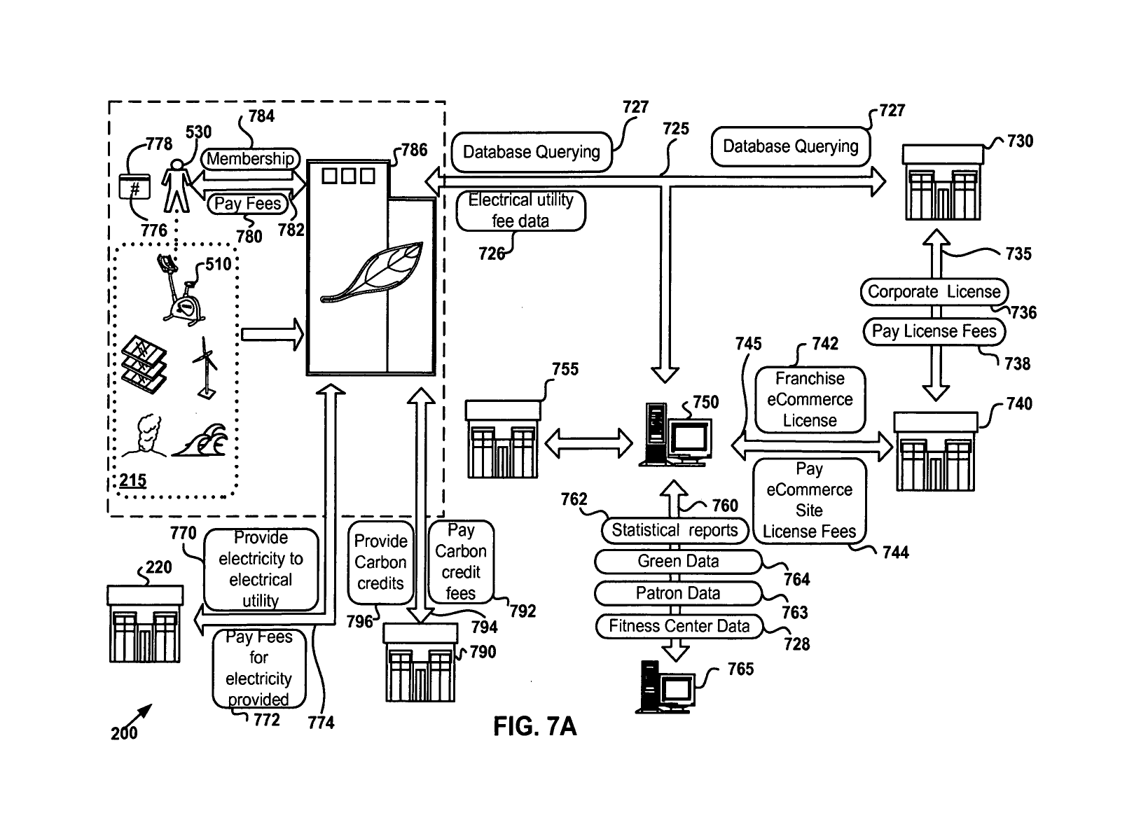

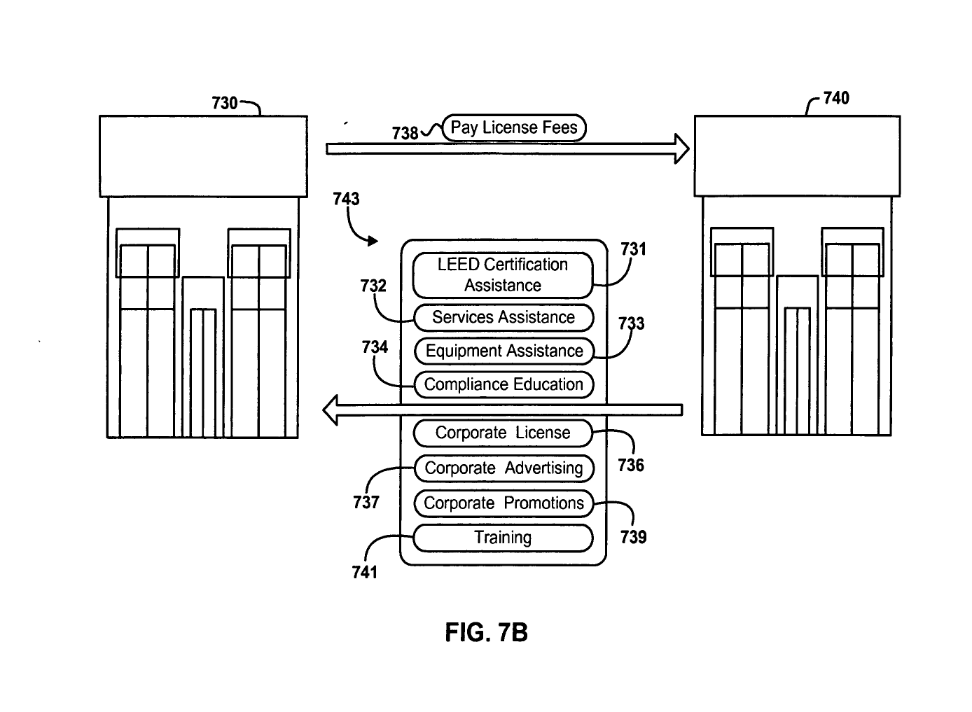

Consumptive process 590 comprises activities and specific goods that contribute to carbon footprint 106. Some consumptive processes 590 contribute to the increasing of carbon footprint 106, while other consumptive processes 590 contribute to the decreasing of carbon footprint 106. Carbon credits 796 (see discussion of FIG. 7A) are preferably assigned based on how much volume of greenhouse gases 105 is involved. Negative credits denote emissions of greenhouse gases 105, while positive credits denote removal of greenhouse gases 105 from the environment. Consumptive process 590 comprises, as shown, waste products 581, energy consumption 582, pollution 583, and carbon based fuel consumption 584 for negative credits as well as recycling 585, renewable energy 210, vegetation growth 587, and energy conservation 588 for positive credits.

Reducing waste products 581 and increasing recycling 585 preferably aid in reducing carbon footprint 106. Energy consumption 582 and associated carbon-dioxide emissions preferably are limited and preferably used efficiently to slow the negative effects of pollution 583. Renewable energy 210 is preferably used, reducing pollution 583 from carbon based fuel consumption 584. Planting and tending to vegetation growth 587 preferably aid in removing some greenhouse gases 105 from the atmosphere. Unnecessary and inefficient use of natural resources decreases the available resources at disposal of patron 530 for future use as well as permanently changes the product into an undesirable form, affecting the health and standard of living of patron 530.

Emission of greenhouse gases 105 may preferably be minimized in production processes to attain a healthy outdoor environment and reduce carbon footprint 106. Greenhouse gases 105 are at least one component of the atmosphere and contribute to the greenhouse effect. Greenhouse gases 105 include water vapor, carbon dioxide, methane, nitrous oxide, ozone and chlorofluorocarbons (CFCs). Greenhouse gases 105 come from both natural environmental sources and human activity. Carbon dioxide levels increase from pollution 583 due to industrial manufacturing and can be reduced using vegetation growth 587. Emission of greenhouse gases 105 are considered negative credits, while carbon offsets mitigate carbon emissions through the development of at least one alternative positive credit project, such as solar energy, wind energy and re-forestation.

Production of electricity from carbon based fuels is one of the largest contributors to carbon footprint 106. As populations and their standard of living increases, energy consumption 582 rises in order to meet the higher demands, and consequently pollution 583 increases. Carbon footprint 106 increases, from energy consumption 582, can be reduced by preferably using renewable resources and by preferably turning off energy-consuming devices when not in use. Water, detergents and electricity requirements are preferably lessened by efficient use of appliances at capacity. Environmentally-friendly fitness center 786, using environmentally-friendly fitness center system 100, preferably strives to decrease carbon footprint 106 by using and generating renewable energy 210, planting and maintaining vegetation growth 587 and promoting recycling 585. (This arrangement at least embodies herein wherein such at least one carbon-footprint reduction method comprises the step of reducing electrical energy consumption; and this arrangement at least embodies herein wherein such at least one carbon-footprint reduction method comprises recycling.)

FIG. 6 shows a diagram of operations system 300, illustrating the interaction between carbon chain 102 and environmentally-friendly fitness center 786, according to the preferred embodiment of FIG. 1. To reduce energy consumption 582, operations system 300 preferably stresses energy efficiency 320. Operations system 300 preferably uses, as shown, at least one solar heating panel 465, reducing energy consumption 582, preferably to heat at least one swimming pool 176, alternately preferably to heat tap water 610 (at least embodying herein wherein such step of reducing electrical energy consumption comprises the step of using solar energy to heat water for use in at least one swimming pool; and at least embodying herein wherein such step of reducing electrical energy consumption comprises the step of using solar energy to heat water for use as hot tap water). Operations system 300 preferably specifies the use of extra insulation 139, as shown, to reduce energy consumption 582 due to environmental temperature control of environmentally-friendly fitness center 786. Extra insulation 139 (at least embodying herein wherein such step of reducing electrical energy consumption comprises the step of using additional insulation to reduce atmospheric-temperature-control electrical energy consumption) increases thermal resistance, preferably keeping heat out during hot weather and heat in during cold weather, effectively reducing energy consumption 582. Extra insulation 139 (at least embodying herein wherein such additional insulation comprises recycled materials) preferably comprises recycled cellulose. Upon reading this specification, those skilled in the art will now appreciate that, under appropriate circumstances, considering such issues as available materials, technological advances, etc., other insulations such as, wool, recycled paper, recycled cotton, denim, etc., may suffice.

Another way to reduce energy consumption 582, preferably used in operations system 300, comprises natural lighting 620, as shown. Natural lighting comprises preferably at least one skylight 183, alternately preferably at least one Solatube® 625 (available from Solatube® International at www.solatube.com). Solatube® 625 is preferably used as a low cost means to light environmentally-friendly fitness center 786 during daylight hours. Solatube® 625 preferably allows light rays to be collected efficiently through effectively increasing the surface area of the surface of a tube mounted on the exterior of environmentally-friendly fitness center 786. Light rays are then preferably reflected and preferably focused down at least one shaft into environmentally-friendly fitness center 786. At least one skylight 183, as shown, may preferably be used to contribute to natural lighting of environmentally-friendly fitness center 786. Natural lighting 620 (at least embodying herein wherein such step of reducing electrical energy consumption comprises the step of using natural lighting) preferably significantly reduces energy consumption 582 due to lighting demands.

Additionally, operations system 300 preferably comprise low-energy lighting 627 (at least embodying herein wherein such step of reducing electrical energy consumption comprises the step of using energy-efficient lighting), as shown, preferably for use at night, comprising preferably CFL lights, alternately preferably LED lights. CFL or LED lights are preferably an economical, efficient lighting means particularly in combination with natural lighting 620. Additionally, many bulbs of low-energy lighting 627 have been shown to have increased longevity, with some bulbs lasting up to 10 years. This means that, in addition to reducing energy consumption 582, low-energy lighting 627 also reduces costs of replacement, maintenance and waste products 581.

Air rehabilitation 340 may preferably be performed at environmentally-friendly fitness center 786, in accordance with operations system 300, to reduce harmful atmospheric contaminants, which may enter environmentally-friendly fitness center 786. Air rehabilitation 340 (at least embodying herein wherein such at least one carbon-footprint reduction method comprises the step of using at least one atmospheric contaminant reduction method), preferably by at least one electrostatic air cleaner 138 (at least embodying herein wherein at least one atmospheric contaminant reduction method comprises the step of using electrostatic air filtration), as shown, alternately preferably by at least one adequate ventilation system 137, also shown, decreases allergic reactions and asthma in at least one patron 530. Appropriate filtration is preferably decided based upon time of year, potential pollutants, and climate conditions. Upon reading this specification, those skilled in the art will now appreciate that, under appropriate circumstances, considering such issues as ventilation and filtering advances, available materials, technological advances, etc., other atmospheric reconditioning methods such as, ambient condition controlled vents, mechanically operated, manually opened/closed or electrically/computer controlled, timer controlled, pollution sensor controlled, chemical filters, natural filters such as plants, water filters, various particulate size air filters, pneumatic filters, etc., may suffice.

Adequate ventilation system 137 will permit human-exhausted carbon-dioxide and unpleasant sweat aroma to be removed to create a healthy indoor environment. Adequate ventilation system 137 preferably displaces the volume of air contained within fitness facilities 150 preferably at least every 10 minutes. This preferably allows waste air to be removed and fresh air preferably brought in to take its place. Continuous airflow preferably will not allow air to become stagnant, thereby creating a healthy indoor environment 104 to be enjoyed by at least one patron 530.

Operations system 300 preferably limits the introduction of harmful atmospheric contaminants into healthy indoor environment 104. Limited pesticide and herbicide use will preferably take place in the immediate vicinity of environmentally-friendly fitness center 786. Additionally, all new low-maintenance furniture and new exercise equipment 510 will preferably be purchased and preferably allowed a period to ‘gas-off’, preferably before being set up in environmentally-friendly fitness center 786. ‘Gas off’ is the term used to refer to a controlled means of allowing harmful gas emissions to be released, over an initial time, from new products. This is most efficiently achieved by air regularly flushed over new materials and equipment to get rid of gasses dangerous for human intake. This act prevents emissions of VOC (Volatile Organic Compounds) from contaminating air in indoor environment 104. Lower-VOC low-odor paint 147 (at least embodying herein wherein at least one atmospheric contaminant reduction method comprises the step of using at least one low-emission paint) will also preferably be used, as shown, to cover surfaces, because there are fewer petroleum products in Lower-VOC low-odor paint 147 and because Lower-VOC low-odor paint 147 has no crystalline silica or carcinogenics. Upon reading this specification, those skilled in the art will now appreciate that, under appropriate circumstances, considering such issues as lower contaminant products, available materials, technological advances, etc., other paints such as, water-based paints, non-aerosol paints, paints with minimal metallic compounds in their formulations, etc., may suffice.

Environmentally-friendly fitness center 786 will preferably have an abundance of vegetation 165, as shown. Vegetation 165 preferably aids in air rehabilitation 340. Vegetation 165 will preferably utilize the abundance of CO₂ given off by at least one patron 530 and preferably replace it with O₂. The additional O₂ available for at least one patron 530 will preferably provide a heightened exercise experience because she will have more energy available. CO₂ will preferably be sequestered by vegetation 165. Sequestering is a technique for the removal of CO₂ or other active compounds so they will not be released into the atmosphere, where they would contribute to the greenhouse effect. This is further useful as a means of monetizing and realizing benefit of such CO₂ recycling process in decreasing carbon-footprint 106.

Vegetation 165 planted at and around environmentally-friendly fitness center 786 will preferably have a more aesthetically pleasing look and feel, preferably creating a sense of being outdoors in nature. Environmentally-friendly fitness center 786 will preferably have a natural green color and preferably pleasant outdoor smell that is fresh for patron 530. This sense of nature preferably adds heightened morale to patron 530 and preferably encourages workouts to last longer. In addition, this sense of nature preferably needs in creating less fatigue and preferably more benefit to exercise regimen. Upon reading this specification, those skilled in the art will now appreciate that, under appropriate circumstances, considering such issues as cost, available materials, technological advances, etc., other outdoor ambience contributors such as, fresh-air filters, nature music, nature videos, slightly increased humidity, more earth tone colors used, greater amount of natural light used and strategically placed to make use of lighting/shadowing effects, etc., may suffice. Vegetation 165 (at least embodying herein wherein such at least one carbon-footprint reduction method comprises planting and maintaining vegetation) also preferably absorbs harmful odors and pollution 583 thereby preferably creating a healthier environment.

Vegetation 165 may also preferably aid in efficient water use 330. At least one green roof 174, as shown, may preferably be used by planting vegetation 165 on fitness facility 150. Green roof 174 preferably forms an insulating layer for at least one fitness facility 150. Additionally, green roof 174 (at least embodying herein wherein such at least one carbon-footprint reduction method comprises recycling rain water) preferably aids in efficient collection of rain and humidity that can be recycled. Vegetation 165 may preferably be used to capture water from rains that falls on environmentally-fiiendly fitness center 786. Vegetation 165 also may preferably capture water from the humidity in the atmosphere. Such captured water may then preferably be transported, preferably by vegetation 165, to at least one storage tank 630 located in fitness facility 150. This recycling of water by natural means preferably leads to less demand for utility treated water.

Vegetation 165 also may preferably recycle grey water used within fitness facility 150. Grey water is non-industrial wastewater generated from domestic processes such as dish washing, laundry and bathing. Grey water may comprise up to 50-80% of residential wastewater. Grey water is distinct from black water in the reduced amount of chemical and biological contaminants such as feces and other toxic chemicals. (This arrangement at least embodies herein wherein such at least one carbon-footprint reduction method comprises recycling grey water.)

Preferably, fitness facility 150 preferably comprises at least one tile floor 190, as shown. Tile floor 190 preferably comprises low carbon-footprint durable materials 360. Tile floor 190 preferably comprises insulative value, preferably is non-flammable and preferably is a renewable resource. Preferably, tile floor 190 comprises Vida Cork™ tile floor (available through Environmental Home Center at www.environmentalhomecenter.com). Vida Cork™ is made from bark from cork trees, which is a renewable resource. Bamboo flooring may alternately preferably be used as tile floor 190. Bamboo flooring is harder than oak and has greater moisture resistance. Bamboo trees are renewable since they are quick to mature for harvest, when compared to other trees. Upon reading this specification, those skilled in the art will now appreciate that, under appropriate circumstances, considering such issues as cost, available materials, technological advances, etc., other flooring materials such as, softwood products, composite tiles, fiberboard, natural linoleum, wool carpeting, etc., may suffice. Solvent-free finishes preferably are used to keep at least one tile floor 190 healthy, in accordance with operations system 300.

Fitness facility 150 preferably comprises at least one high-efficiency toilet 191. At least one high-efficiency toilet 191 comprises at least one Caroma® toilet (available from Caroma at http://www.caromausa.com/) using dual-flushing systems and wasting less water than conventional systems. Actual usage of conventional toilets may range from 700 to 1100 liters per day putting a strain on water reserves, and waste handling stations. Flush volumes can be reduced by up to 68% in family dwellings, up to 56% in office washrooms and up to 52% in restaurants, when single-flush conventional toilets are replaced with dual-flush installations. Upon reading this specification, those skilled in the art will now appreciate that, under appropriate circumstances, considering such issues as environmentally-friendly plumbing fixtures, available materials, technological advances, etc., other high-efficiency toilets such as, waterless urinals, grey-water toilets, etc., may suffice.

Environmentally-friendly fitness center system 100 preferably comprises water treatment method 640, as shown, preferably for swimming pool 176 and preferably for other such water installations. Water treatment method 640 preferably comprises at least one oxygen treating system 645 to minimize chlorine and bromine use. Due to reduced chlorine, patron 530 preferably experiences fewer negative effects such as dry, itchy eyes, dry hair, skin irritations and asthmatic reactions. Treated water is also preferably neutral when reintroduced into the environment as waste-water. Oxygen treating system 645 may eliminate up to about 90% of sodium hypochlorite use, preferably to help more efficiently control odor, microbes and water clarity. Oxygen treating system 645 is preferably very inexpensive to run. Oxygen treating system 645 preferably relies on oxygen electrodes to shock water in swimming pool 176 preferably as it passes through at least one pressure line. Oxygen treating system 645 may alternately preferably inject oxygen 444, generated in hydrogen-energy storage system 430, into water preferably as it passes through such at least one pressure line. Oxygen treating system 645 is preferably very thrifty in the amount of electrical power 205 it consumes. Upon reading this specification, those skilled in the art will now appreciate that, under appropriate circumstances, considering such issues as environmentally-responsible water treatment systems, available materials, technological advances, etc., other water treatment methods such as, salt water solutions, ozone filtration systems, etc., may suffice.

FIG. 7A shows a diagram of environmentally-friendly fitness center business system 130, illustrating at least one preferred business relationship associated with environmentally-friendly fitness center system 100, according to the preferred embodiment FIG. 1. Environmentally-friendly fitness center business system 130 is preferably optimized for collecting, converting and recycling electrical power 205 generated preferably by human exercising and preferably other renewable energy sources, preferably to use and preferably to sell to utility company 270. Further, environmentally-friendly fitness center business system 130 preferably comprises the use of fitness facility 150, preferably utilizing low-resource consumption facilities and preferably low carbon-footprint operations.

Environmentally-friendly fitness center business system 130, at a high level of abstraction, preferably monetizes the exchange of renewable electrical energy by providing environmentally-friendly fitness center 786 comprising fitness facility 150, where patron 530 may preferably generate electricity while preferably performing at least one exercising regiment preferably on exercise equipment 510. Environmentally-friendly fitness center business system 130 preferably further monetizes carbon credits 796 from the decrease of carbon footprint 106 associated with both fitness facility 150 and operations system 300, by selling carbon-credits through carbon-credit market aggregator 790. The parties involved in environmentally-friendly fitness center business system 130 comprise carbon-credit market aggregator 790, utility company 270, environmentally-friendly fitness center 786, corporate entity 730, and business-method licenser 740, as shown.

Environmentally-friendly fitness center business system 130 preferably involves business-method licenser 740 preferably providing corporate license 736 to corporate entity 730 in return for corporate entity 730 preferably providing corporate-license fees 738, as shown, to business-method licenser 740 preferably forming at least one licensee/licensor business relationship 735 (at least embodying herein franchising at least one environmentally-friendly fitness center business method). Corporate license 736 preferably enables corporate entity 730 database querying functionality 727 via e-commerce site 750, preferably by connection 725, as shown. Database querying functionality 727 preferably allows querying at least one server farm 765 preferably for green data 764, electrical utility fee data 726, patron data 763 and fitness center data 728.

As part of environmental friendly fitness center business system 130, at least one e-commerce site 750 preferably obtains franchise e-commerce license 742 from business-method licenser 740 preferably in exchange for at least one e-commerce site license fee 744, forming e-commerce business relationship 745, as shown. Franchise e-commerce license 742 preferably entitles e-commerce site 750 to operate preferably using data from server farm 765 using network connection 760, as shown. Additionally, franchise e-commerce license 742 preferably entitles e-commerce site 750 to provide services to corporate entity 730, patron 530 and environmentally-friendly fitness center 786. E-commerce site 750 preferably monetizes advertising space with at least one green advertiser 755, as shown.

Additionally, corporate license 736 preferably enables corporate entity 730 to allow patron 530 to link, using connection 725, preferably to e-commerce site 750, as shown, preferably to input patron data 763 and green data 764 into server farm 765. Still additionally, corporate license 736 preferably enables corporate entity 730 to allow environmentally-friendly fitness center 786 to link, through connection 725, preferably to server farm 765, as shown, preferably to input fitness center data 728. Corporate license 736 preferably further enables environmentally-friendly fitness center 786 to allow patron 530 to retrieve statistical reports 762 preferably on patron data 530 and green data 530 from server farm 765, through e-commerce site 750. Additionally, with corporate license 736, environmentally-friendly fitness center 786 may preferably retrieve statistical reports 762, preferably on fitness center data 728, patron data 530 and green data 530 from server farm 765. Still additionally, corporate license 736 preferably enables environmentally-friendly fitness center 786 to access, through connection 725, database querying functionality 727 of environmentally-friendly fitness center system 100, as shown.

Thus, also, environmentally-friendly fitness center system 100 preferably enables corporate entity 730 (having paid license fees 738) to have remote connectivity to: 1) patron 530, preferably by membership connection 782; 2) utility company 270, preferably by utility connection 774, and 3) carbon-credit market aggregator 790, preferably by carbon-credit connection 794, as shown.

As part of environmentally-friendly fitness center business system 130, environmentally-friendly fitness center 786 preferably offers at least one membership 784 to patron 530, good for use of services of environmentally-friendly fitness center 786, in exchange for at least one membership fee 780, thus forming membership connection 782, as shown. Membership fee 780 comprises preferably monetary compensation, alternately preferably carbon-credit generation, alternately preferably electricity generation. In conjunction with membership connection 782, patron 530 is preferably issued at least one membership number 776, preferably on at least one membership card 778, as shown. Membership number 776 is preferably entered into instrumentation panel 517, preferably by swiping membership card 778, before patron 530 uses exercise equipment 510. Green data 764, generated during use of exercise equipment 510 by patron 530, is preferably tracked and stored, in server farm 765, preferably connected to membership number 776. Thus, environmentally-friendly fitness center business system 130 preferably directly monetizes at least one use of environmentally-friendly fitness center system 100 via sales of membership 784.

Utility connection 774 is preferably formed, as shown, between environmentally-friendly fitness center 786 and utility company 270 preferably for the exchange of renewable energy 210. As discussed in FIGS. 2 & 4, on-site energy source 215 preferably generates renewable energy 210 supplying power preferably for use in fitness facility 150. Surplus renewable energy 210 is preferably provided to utility company 270 preferably in exchange for credit to electricity fees 772, as shown (this arrangement at least embodying herein selling such generated electrical power to at least one electrical utility company; and this arrangement at least embodying herein at least one environmentally-friendly power monetizing method). Additionally, utility company 270 may preferably provide renewable energy 210 to environmentally-friendly fitness center 786 in exchange for electricity fees 772, as shown, when power demand exceeds production from on-site energy source 215. Thus, environmentally-friendly fitness center business system 130 preferably directly monetizes at least one use of environmentally-friendly fitness center system 100 via exchange of renewable energy 210, as shown.

Carbon-credit connection 794 is preferably formed between environmentally-friendly fitness center 786 and carbon-credit market aggregator 790, as shown, preferably implementing the monetization of carbon credits 796 relating to carbon footprint 106 from operation system 300. Carbon-credit market aggregator 790 preferably validates carbon credits 796 earned, preferably assists in the sale of carbon credits 796, and preferably collects carbon credit fees 792 associated with such sale of carbon credits 796. Carbon credits 796 are preferably awarded to corporate entity 730 preferably based upon the amount of reduction of carbon-footprint 106 and preferably based on other positive environmental impacts, preferably based on green data 764 (this arrangement at least embodying herein obtaining at least one carbon credit due to such step of purposefully instituting at least one carbon-footprint reduction method). Carbon credits 796 are preferably aggregated by carbon-credit market aggregator 790. Carbon credits 796 may preferably be brokered and preferably traded as an ‘offset’ commodity preferably to individuals or companies that create a larger carbon-footprint 106. Thus, environmentally-friendly fitness center business system 130 preferably directly monetizes at least one use of environmentally-friendly fitness center system 100 via generation of carbon credits 796, as shown. (This arrangement at least embodies herein monetizing such at least one carbon credit through at least one carbon-credit aggregator; and this arrangement at least embodies herein at least one carbon-credit monetizing method.)

FIG. 7B shows a diagram of licensee/licensor business relationship 735, illustrating at least one support service 743 made available to corporate entity 730, according to the preferred embodiment of FIG. 1. Once licensee/licensor business relationship 735 is formed, support service 743 is preferably offered to corporate entity 730 preferably to assist in the setup and maintenance of environmentally-friendly fitness center 786, as shown. Support service 743 preferably comprises, as shown, training 741, alternately preferably at least one corporate promotion 739, alternately preferably corporate advertising 737, alternately preferably compliance education 734, alternately preferably equipment assistance 733, alternately preferably green services assistance 732, alternately preferably LEED certification assistance 731. Upon reading the specification, those skilled in the art will now appreciate that, under appropriate circumstances, considering such issues as future technologies, scientific research, cost, etc., other support services, such as, for example, assistance for other environmentally-friendly certification programs, equipment rental services, carbon credit brokering services, etc., may suffice.

Some of support services 743 are preferably designed to assure the compliance of corporate entity 730 to environmentally-friendly fitness center system 100. Training 741 preferably comprises disseminating information, preferably about business practices of environmentally-friendly fitness center system 100, preferably to employees of corporate entity 730. Training 741 preferably covers operations system 300 and preferably appropriate training in powering system 200 as well as maintenance of the equipment, as discussed in FIGS. 4 & 6, used in these systems. Compliance education 734 preferably comprises disseminating information preferably about laws governing at least one portion of environmentally-friendly fitness center system 100. Equipment assistance 733 preferably comprises assistance relating to the equipment used in operations system 300 and powering system 200, preferably in finding, alternately preferably in maintaining, alternately preferably in obtaining. Green services assistance 732 preferably comprises assistance relating to third-party services, preferably in finding recommended services, alternately preferably in validating services as environmentally-friendly. LEED certification assistance 731 preferably comprises assistance preferably in understanding and preferably implementing practices and procedures preferably as outlined by the U.S. Green Building Council as the LEED (Leadership in Energy and Environmental Design) Green Building Rating System. LEED certification requirements are available at www.usgbc.org/leed/. LEED certification assistance 731 preferably leads to the approval of fitness facility 150 as preferably certified, alternately preferably silver certified, alternately preferably gold certified, alternately preferably platinum certified according to LEED certification standard (at least embodying herein wherein exercising facility is certified by at least one locally-recognized environmentally-friendly building code). These services are preferably offered to aid corporate entity 730 preferably in establishing acceptable practices for fitness facility 150 and preferably in operation of environmentally-friendly fitness center 786.

Other support services 743 are preferably designed to promote the use of environmentally-friendly fitness center 786. Corporate advertising 737 preferably comprise national ad campaigns promoting the use of environmentally-friendly fitness center 786, alternately preferably local ad campaigns. Corporate advertising 737 may preferably include at least one location of environmentally-friendly fitness center 786 within a localized area. Corporate promotion 739 preferably comprises at least one contest, alternately preferably at least one special offer, alternately preferably at least one competition. Such at least one contest may preferably include prizes for patron 530, preferably achieved through reaching at least one level of production of electrical power 205.

Such at least one contest preferably encourages patron 530 to contribute to the reduction of carbon footprint 106. Such at least one special offer may preferably include reduced cost memberships, alternately preferably free workout times, alternately preferably cost mitigating programs. Such at least one special offer preferably encourages community involvement and increases in memberships. Such at least one competition may preferably include at least one competitive scoreboard preferably using patron data 763, preferably fitness center data 728 and preferably green data 764, preferably for both individual patron competitions and preferably competitions between different locations of environmentally-friendly fitness center 786. Such at least one competition preferably increases the use of environmentally-friendly fitness center 786 and preferably fosters community involvement and pride preferably in contributing to the environment. Patron 530 is preferably attracted to the advocacy of a wholesome lifestyle and preferably of team spirit camaraderie, where patron 530 can preferably exercise in a healthy indoor environment 104, preferably while helping to improve the global environment, preferably by reducing greenhouse gases 105. At least one sponsor may be required, preferably for promoting and preferably funding such at least one competition between participants. Such at least one sponsor preferably receives the benefit, pride, and recognition preferably from being associated with environmentally-friendly fitness center system 100 in such at least one competition.

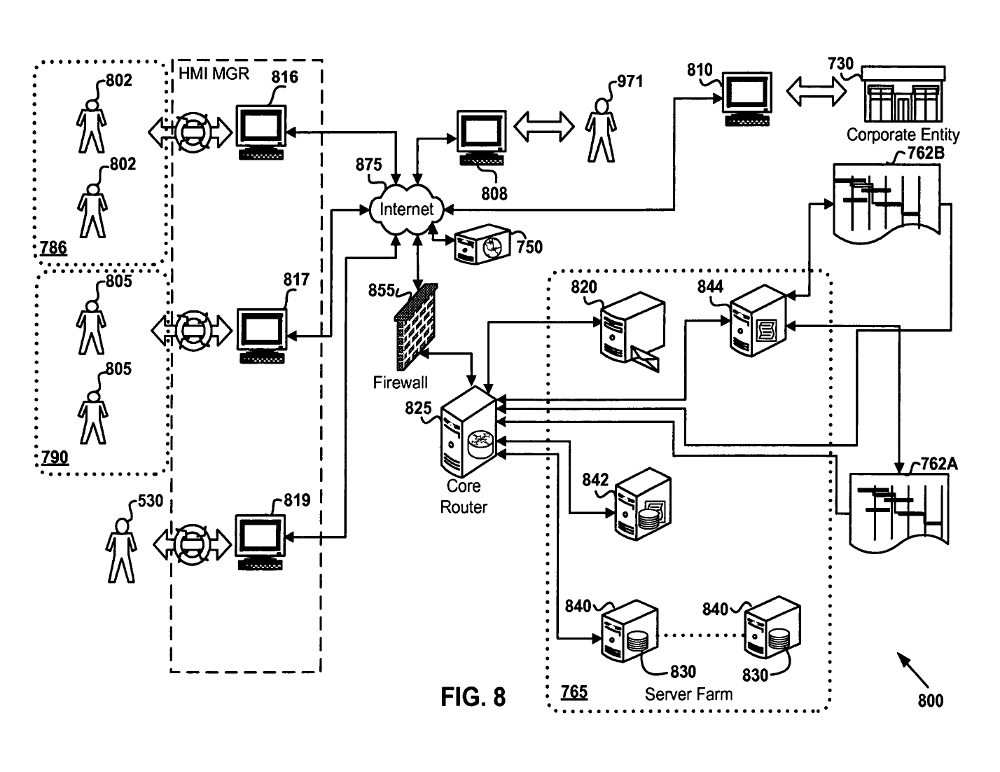

FIG. 8 shows a schematic block diagram of data-communication architecture 800, illustrating data exchange and processing of environmentally-friendly fitness center system 100, according to the preferred embodiment of FIG. 1. Data-communication architecture 800 preferably provides connectivity to server farm 765 preferably for the exchange of data, as shown. Server farm 765 preferably comprises, as shown, at least one database server 840, preferably at least one data processing server 842, preferably at least one reporting system 844, and preferably at least one messaging server 820.

Database server 840 preferably comprises at least one database 830, as shown, preferably capable of storing green data 764, preferably patron data 763, preferably fitness center data 728, and preferably electrical utility fee data 726 of environmentally-friendly fitness center system 100. Database processing server 842 preferably processes and preferably provides access, as shown, for reporting system 844 to green data 764, preferably patron data 763, preferably fitness center data 728, and preferably electrical utility fee data 726. Reporting system 844 preferably compiles green data 764, preferably patron data 763, preferably fitness center data 728, and preferably electrical utility fee data 726 preferably into statistical reports 762. Statistical reports 762 preferably comprise, as shown, at least one individual patron statistical report 762A and preferably at least one group statistical report 762B. Patron 530 preferably has access to individual patron statistical report 762A as well as group statistical report 762B preferably for at least one group in which patron 530 participates.

Green data 764 preferably comprises exerciser performance and carbon-footprint data preferably comprising energy production, time of use, exercise equipment 510 used, group affiliations, and location of fitness facility 150 used. Patron data 763 preferably comprises information about patron 530, preferably including name, address and contact information. Green data 764 is preferably useful for tracking carbon-footprint reduction contributions preferably by patron 530, preferably by environmentally-friendly fitness center 786 and preferably by corporate entity 730. Green data 764 is preferably further useful in reporting carbon-footprint reductions, preferably for marketing purposes, which preferably leads to the promotion of a positive environmentally-friendly image for environmentally-friendly fitness center 786.

Messaging server 820 preferably provides intercommunication between parties associated with environmentally-friendly fitness center system 100. Messaging server 820 may preferably be used by corporate entity 730, preferably to facilitate communications with environmentally-friendly fitness center 786. Messaging server 820 preferably may also be used preferably by environmentally-friendly fitness center 786, preferably to facilitate communications with patron 530. Additionally, messaging server 820 preferably provides communications between one patron 530 and another patron 530 preferably in such at least one group. Such communications may be used preferably to encourage, preferably to motivate, and preferably to acknowledge efforts to reduce carbon footprint 106 as well as preferably provide information of interest to participants in environmentally-friendly fitness center system 100.

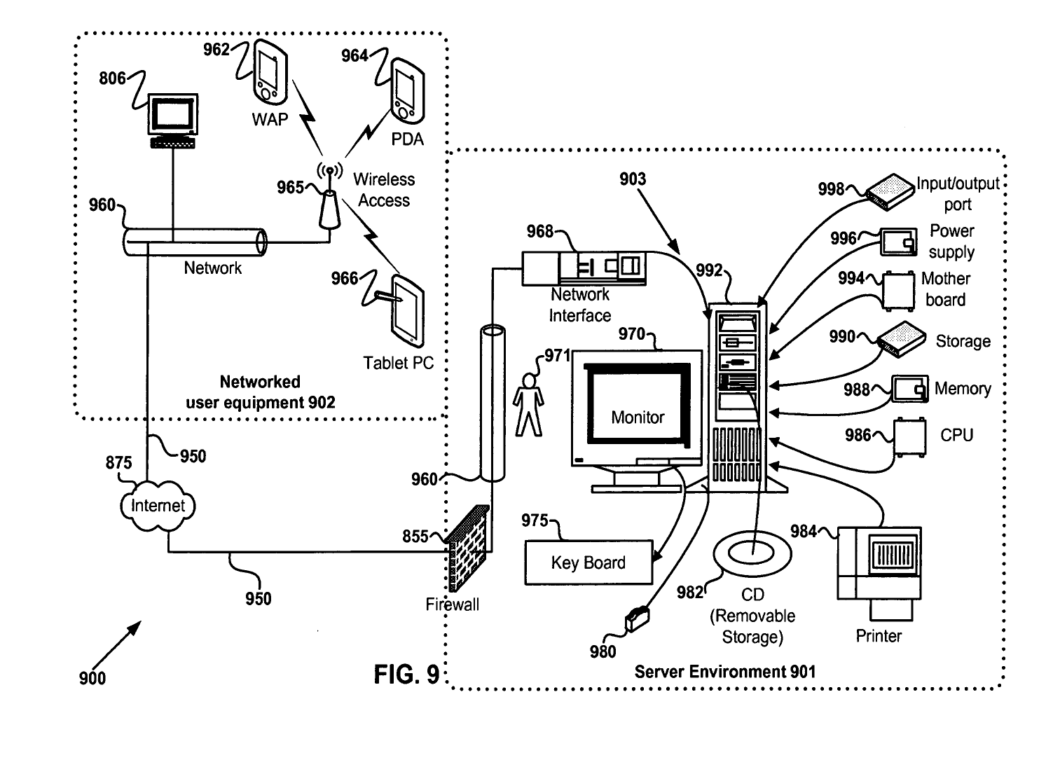

Server farm 765 is preferably electronically interconnected through at least one core router 825, as shown, which preferably provides access through at least one firewall 855 preferably to the Internet 875. Internet 875 preferably provides network interconnectivity for data-communication architecture 800, as shown. As shown, at least one administrator 971 preferably uses at least one administrator PC 808, preferably with connectivity to Internet 875, preferably to administrate server farm 865, alternately preferably to administrate e-commerce site 750. E-commerce site 750 preferably uses at least one connection to Internet 875, as shown, preferably to retrieve green data 764 and preferably statistical reports 762 from server farm 765. Corporate entity 730 preferably uses connectivity to Internet 875, preferably through at least one corporate PC 810, as shown, preferably to communicate with server farm 765 preferably retrieving green data 764 and preferably statistical reports 762 as well as preferably use communications services provided by messaging server 820. At least one employee 802 of environmentally-friendly fitness center 786, using at least one facility PC 816 to connect to Internet 875, as shown, preferably may likewise communicate with server farm 765 preferably to retrieve green data 764 and preferably statistical reports 762 as well as preferably to use communications services provided by messaging server 820. Patron 530 preferably uses at least one user PC 819, with connectivity to Internet 875, as shown, preferably to retrieve green data 764 and preferably statistical reports 762 from server farm 765 preferably via e-commerce site 750. At least one employee 805 of carbon-credit market aggregator 790 preferably uses at least one aggregator PC 817, as shown, preferably to communicate through Internet 875 to server farm 765 preferably to retrieve green data 764 preferably for the purposes of validating and assigning carbon credits 796. Corporate PC 810, facility PC 816, aggregator PC 817, user PC 819 and administrator PC 808 preferably comprise network user equipment 902 as described in FIG. 9.

FIG. 9 shows a schematic block diagram view, of a typical hardware environment 900 for an implementation of environmentally-friendly fitness center business system 130 for environmentally-friendly fitness center system 100, according to the preferred embodiment of FIG. 1. Hardware environment 900 preferably comprises server environment 901 and preferably networked user equipment 902, as shown. Additionally, as shown, server environment 901 preferably comprises at least one server 903, preferably comprising: at least one input/output port 998; at least one power supply 996; at least one motherboard 994; at least one chassis 992; at least one storage device 990; at least one memory storage device 988; at least one CPU 986 (central processing unit); at least one printer 984; at least one removable storage medium 982; at least one mouse 980; at least one keyboard 975; at least one monitor 970; at least one network interface 968; at least one network 960; at least one firewall 855; and at least one internet connection 950. Further, as shown, networked user equipment 902 preferably comprises at least one firewall 855, preferably at least one internet connection 950, and preferably at least one user device comprising: preferably at least one PC 806 (personal computer); alternately preferably at least one WAP enabled device 962 (Wireless Access Protocol); alternately preferably at least one PDA 964 (personal data assistant); alternately preferably at least one tablet PC 966. Networked user equipment 902 preferably further comprises at least one network 960, preferably at least one wireless network access 965. Upon reading the teachings of this specification, those skilled in the art will now appreciate that, under appropriate circumstances, considering such issues as changes in technology, user requirements, etc., other service oriented architectures, such as, for example, peer-to-peer network architectures, application architectures yet to be developed, etc., may suffice.

As shown, hardware environment 900 may preferably be used to enable data-flows preferably across data communication architecture 800 (see FIG. 8), preferably including: at least one client machine (represented herein as PC 806); at least one network connectivity link (represented herein as Internet 875) with firewall 855—also, at least one presentation tier (represented herein as e-commerce site 750, messaging server 820)—also, at least one application (business) tier (represented herein as reporting system 844)—also, at least one database tier (represented herein as database server 840). Upon reading the teachings of this specification, those with ordinary skill in the art will now understand that, under appropriate circumstances, considering issues such as changes in data communications architectures and computing technology, etc., other data communications and computing constructs, such as, for example, interlaced N-tier communications and computing architectures, pier-to-pier communication architectures, etc., may suffice.

Chassis 992 of server environment 901, as shown, preferably houses all components that make up server environment 901 and preferably provides at least one input/output port 998. Chassis 992 preferably comprises Dell®, mini-tower PC chassis configuration. Motherboard 994 of server environment 901 preferably comprises the main logic circuitry and preferably, as shown, provides all necessary circuitry to interconnect all components of server environment 901. Motherboard 994 preferably comprises DFI® LANPARTY UT Series motherboard preferably with ATI® CrossFire® chipset and RAID controller. Upon reading the teachings of this specification, those with ordinary skill in the art will now understand that, under appropriate circumstances, considering issues such as changes in computer server environment technology, etc., other computer server subassembly and component constructs including elements, such as, for example, highly-integrated motherboards, blade-computer housings yet to be developed, etc., may suffice.

Power supply 996 of server environment 901 preferably comprises a redundant arrangement of individual power supplies that together preferably provide a fail-safe means of providing necessary power for all server environment 901 components. Power supply 996 preferably comprises rating at 150% of maximum use capacity, preferably operating in hot-standby mode. Power supply 996 preferably comprises at least one 300 watt power supply. Upon reading the teachings of this specification, those with ordinary skill in the art will now understand that, under appropriate circumstances, considering issues such as changes in power-inverter technology, etc., other power supply designs, such as, for example, switch-mode invertors and converter power supplies, high-frequency inductive and capacitive power supplies, etc., may suffice.

Storage device 990 of server environment 901, as shown, is preferably configured as a Redundant Array of Independent Drives (RAID) preferably having mirroring (copying of data to more than one physical disk); preferably having striping (splitting of data across more than one physical disk), and preferably error correction or preferably fault tolerance (redundant storing of data that allows detecting and fixing of data-integrity anomalies). Storage device 990 preferably comprises a RAID-5 configuration of preferably with at least four-each physical-disc storage, preferably sized for use in environmentally-friendly fitness center system 100, preferably with at least one serial-attached SCSI 3 Gbps interface. Upon reading the teachings of this specification, those skilled in the art will now appreciate that, under appropriate circumstances, considering issues such as changes in electronic data storage technology, etc., other storage devices, such as, for example, semiconductor storage devices, optical storage devices, organic storage devices, etc., may suffice.

Memory storage device 988 of server environment 901, as shown, preferably includes dynamic RAM (random access memory), preferably semiconductor chips that store system software, programs, and data currently used. Memory storage device 988 preferably comprises volatile memory, that is, the memory contents of which may be lost when/if server environment 901 loses power. Thus, contents of memory storage device 988 preferably must be stored in storage device 990 prior to powering down server environment 901. Memory storage device 988 is preferably sized to sustain 150% of the memory requirements of environmentally-friendly fitness center system 100, preferably with fully buffered DIMM (dual inline memory module) memory. Upon reading the teachings of this specification, those with ordinary skill in the art will now understand that, under appropriate circumstances, considering issues such as changes in semiconductor dynamic memory technology, related semiconductor packaging technology, etc., other memory storage devices, such as, for example, bi-polar semiconductor circuits, compatible miniaturized-packaging storage devices, biological storage devices, etc., may suffice.

CPU 986 of server environment 901, as shown, preferably interprets and preferably executes actual computing tasks of environmentally-friendly fitness center system 100 and preferably has capacity for simultaneously executing multiple processing threads (parallel processing). CPU 986 preferably comprises at least one dual-core 64-bit Intel® Xeon® processor. Upon reading the teachings of this specification, those with ordinary skill in the art will now understand that, under appropriate circumstances, considering issues such as changes in semiconductor processing technology, semiconductor processor packaging technology, etc., other central processing units, such as, for example, quad core processors, biological processors, optical processors, etc., may suffice.

Printer 984 of server environment 901, as shown, preferably has a standards-based interface with input/output port 998 and preferably is capable of generating reports as necessary to adequately communicate information to at least one administrator 971 of server environment 901 in environmentally-friendly fitness center system 100. Printer 984 preferably comprises Dell® 1720 laser printer. Upon reading the teachings of this specification, those with ordinary skill in the art will now understand that, under appropriate circumstances, considering issues such as changes in printing technology, print-media technology, etc., other printing and information conveying systems, such as, for example, non-impact carbon deposition technologies, low-environmental impact temporary media, etc., may suffice.

Removable storage medium 982 of server environment 901, as shown, preferably protects data of environmentally-friendly fitness center system 100 from accidental loss, when used as a backup, if server environment 901 hardware or storage media fails. Removable storage medium 982 preferably establishes at least one backup (preferably duplicate copies of data of environmentally-friendly fitness center system 100) preferably on archival media that preferably may be stored in at least one other storage device and preferably retrieved for later use. Removable storage medium 982 preferably comprises a single 24× IDE CD-ROM drive and CD-ROM discs. Upon reading the teachings of this specification, those with ordinary skill in the art will now understand that, under appropriate circumstances, considering issues such as changes in long-term electronic data storage and data transfer technology, etc., other backup storage devices, such as, for example, Internet connected disk-arrays, dynamic storage devices, and static storage devices yet to be developed, etc., may suffice.

Mouse 980 of server environment 901, as shown, preferably has a standards-based interface with input/output port 998 and preferably is capable of conveying signals to CPU 986 via a curser, preferably via monitor 970 or equivalent. Mouse 980 preferably comprises at least one USB 2-button optical mouse, as shown, preferably with at least one scroll function, or equivalent. Upon reading the teachings of this specification, those with ordinary skill in the art will now understand that, under appropriate circumstances, considering issues such as changes in computer pointing-device technology, human-machine interface technology, etc., other computer pointing devices, such as, for example, laser-based pointers or biometric-based pointers, etc., may suffice.

Keyboard 975 of server environment 901, as shown, preferably has a standards-based interface preferably with input/output port 998 and is preferably capable of conveying signals to CPU 986 via at least one keyboard-like interface. Keyboard 975 preferably allows administrator 971 to enter commands preferably to direct executions of server 903 used in environmentally-friendly fitness center system 100 preferably within preferred server environment 901. Keyboard 975 preferably comprises at least one USB keyboard, preferably with at least one hot-key. Upon reading the teachings of this specification, those with ordinary skill in the art will now understand that, under appropriate circumstances, considering issues such as changes in human-machine interface technology, computer input/output technology, etc., other input and output devices, such as, for example, optical readers and encoders, biometric readers, biometric decoders, etc., may suffice.

Monitor 970 of server environment 901, as shown, preferably comprises the capability of displaying at least one input/output text message and at least one graphic symbol, preferably associated with server 903 used in environmentally-friendly fitness center system 100, preferably with sufficient resolution and clarity that administrator 971 preferably may effectively act in an administrator role with server 903. Monitor 970 preferably comprises at least one Dell® UltraSharp™ flat panel, preferably with VGA resolution, preferably with at least one Intel® GMA3000 video card. Upon reading the teachings of this specification, those with ordinary skill in the art will now understand that, under appropriate circumstances, considering issues such as changes in computer display technology, cost, etc., other displays, such as, for example, liquid-crystal-based displays, light-emitting-diode displays, holographic displays, etc., may suffice.

Network interface 968 preferably enables server environment 901 to send at least one communication signal and to preferably receive at least one communication signal from network 960, preferably using at least one standards-based communication-protocol. Network interface 968 preferably comprises at least one dual embedded Broadcom® NetXtreme II 5708 Gigabit Ethernet network interface card. Upon reading the teachings of this specification, those with ordinary skill in the art will now understand that, under appropriate circumstances, considering issues such as changes in high-speed data communications technology, etc., other protocols, such as, for example, token-based protocols, packet-based protocols, etc., may suffice.

Firewall 855, as shown, preferably isolates network 960 from Internet 875, preferably permitting only specific traffic to pass into or out of server environment 901. Firewall 855 preferably selectively blocks data traffic, preferably at ISO/OSI layer 3 and layer 4, and preferably has state knowledge of all data connectivity sessions passing through firewall 855. Firewall 855 preferably minimally has: IEEE 802.1x based edge authentication; switch access password protection; at least one user-definable setting for enabling or disabling Web, SSH, Telnet, SSL management access; at least one port-based MAC address alert and lock-down; IP address filtering for management access Layer 2/3/4-based Access Control Lists (ACLs); RADIUS and TACACS+ remote authentication; and SSL/SSH encryption. Upon reading the teachings of this specification, those skilled in the art will now understand that, under appropriate circumstances, considering issues such as changes in data-encryption technology, firewalling technology etc., other data-network firewalling constructs, such as, for example, multi-layer intrusion detection/prevention, hashing algorithms, software firewalls, etc., may suffice.

Wireless network access 965 preferably enables wirelessly networked user equipment 902 to send at least one communication signal preferably to at least one other network-enabled device, preferably using at least one standards-based communication protocol. Preferred wireless network access 965 preferably comprises Linksys® WRVS4400N Wireless-N Security Router. Upon reading the teachings of this specification, those skilled in the art will now understand that, under appropriate circumstances, considering issues such as changes in wireless data-communications technology wireless data-transmission protocols, etc., other wired or wireless data and multi-media communications technologies including constructs, such as, for example, laser-based wireless communications technologies, spread-spectrum wireless communications technologies, etc., may suffice.

Internet connection 950 of networked user equipment 902, as shown, preferably has sufficient bandwidth and latency characteristics (data connectivity) such that environmentally-friendly fitness center system 100 preferably may properly execute all functions preferably with all user devices, using environmentally-friendly fitness center system 100, preferably comprising: WAP enabled device 962; PC 806; PDA 964; and tablet PC 966. Internet connection 950 preferably comprises a minimum of about one-megabit bandwidth (bi-directional) preferably with latency of less then about 100 milliseconds. Upon reading the teachings of this specification, those skilled in the art will now understand that, under appropriate circumstances, considering issues such as changes in networked-user-equipment technology, miniaturized human-machine interact technology, etc., other networked-user-equipment, such as, for example, integrated networks allowing for multi-media store and forward, real-time communications via touch-sensitive input/output interfaces, biometrics interface devices, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

Appendix A, incorporated by reference hereby and made a part of this specification, illustrates/discusses preferred environmentally-friendly fitness center system business method concepts.

Appendix B, incorporated by reference hereby and made a part of this specification, illustrates/discusses preferred environmentally-friendly fitness center infrastructure concepts.

Appendix C, incorporated by reference hereby and made a part of this specification, illustrates/discusses preferred environmentally-friendly fitness center system equipment details.

What is claimed is:

1) A method comprising the steps of:
a) operating at least one exercise facility;
b) generating electrical power locally at such at least one exercise facility;
c) wherein such step of generating electrical power comprises the steps of
i) converting human kinetic energy into electrical power, and
ii) generating electrical power using at least one other-than-human renewable energy source; and
d) using such generated electrical power to assist in powering such at least one exercise facility.

2) The method according to claim 1 wherein such at least one other-than-human renewable energy source comprises solar energy.

3) The method according to claim 1 wherein such at least one other-than-human renewable energy source comprises wind energy.

4) The method according to claim 1 wherein such at least one other-than-human renewable energy source comprises geothermal energy.

5) The method according to claim 1 wherein such at least one other-than-human renewable energy source comprises tidal energy.

6) The method according to claim 1 wherein such at least one other-than-human renewable energy source comprises hydroelectric energy.

7) The method according to claim 1 further comprising the step of selling such generated electrical power to at least one electrical utility company.

8) The method according to claim 1 wherein such step of operating at least one exercise facility comprises the step of purposefully instituting at least one carbon-footprint reduction method.

9) The method according to claim 8 wherein such at least one carbon-footprint reduction method comprises planting and maintaining vegetation.

10) The method according to claim 8 wherein such at least one carbon-footprint reduction method comprises recycling.

11) The method according to claim 10 wherein such at least one carbon-footprint reduction method comprises recycling grey water.

12) The method according to claim 10 wherein such at least one carbon-footprint reduction method comprises recycling rain water.

13) The method according to claim 8 wherein such at least one carbon-footprint reduction method comprises the step of reducing electrical energy consumption.

14) The method according to claim 13 wherein such step of reducing electrical energy consumption comprises the step of using solar energy to heat water for use in at least one swimming pool.

15) The method according to claim 13 wherein such step of reducing electrical energy consumption comprises the step of using solar energy to heat water for use as hot tap water.

16) The method according to claim 13 wherein such step of reducing electrical energy consumption comprises the step of using natural lighting.

17) The method according to claim 13 wherein such step of reducing electrical energy consumption comprises the step of using energy-efficient lighting.

18) The method according to claim 13 wherein such step of reducing electrical energy consumption comprises the step of using additional insulation to reduce atmospheric-temperature-control electrical energy consumption.

19) The method according to claim 18 wherein such additional insulation comprises recycled materials.

20) The method according to claim 8 wherein such at least one carbon-footprint reduction method comprises the step of using at least one atmospheric contaminant reduction method.

21) The method according to claim 20 wherein the step of using at least one atmospheric contaminant reduction method comprises the step of using electrostatic air filtration.

22) The method according to claim 20 wherein the step of using at least one atmospheric contaminant reduction method comprises the step of using at least one low-emission paint.

23) The method according to claim 8 wherein such at least one carbon-footprint reduction method comprises the step of complying with at least one locally-recognized environmentally-friendly building code.

24) The method according to claim 8 wherein such at least one locally-recognized environmentally-friendly building code comprises LEED Green Building Rating System.

25) The method according to claim 1 further comprising the step of storing such generated electrical power in at least one local storage device when such generated electrical power exceeds such generated electrical power being locally used.

26) The method according to claim 25 wherein such at least one local storage device comprises at least one battery.

27) The method according to claim 25 wherein such at least one local storage device comprises at least one hydrogen energy storage method.

28) The method according to claim 27 wherein such at least one hydrogen energy storage method comprises the steps of:
a) disassociating hydrogen gas in water in at least one electrolysis chamber; and
b) storing disassociated hydrogen gas in at least one hydrogen storage tank.

29) The method according to claim 28 further comprising the step of retrieving such stored electrical power using at least one hydrogen fuel cell.

30) The method according to claim 8 further comprising the step of obtaining at least one carbon credit due to such step of purposefully instituting at least one carbon-footprint reduction method.

31) The method according to claim 30 further comprising the step of monetizing such at least one carbon credit through at least one carbon-credit aggregator.

32) An exercise facility comprising:
a) at least one local electrical power generator structured and arranged to generate electrical power locally at said exercise facility;
b) wherein said at least one local electrical power generator comprises at least one human kinetic energy converter structured and arranged to convert human kinetic energy into electrical power; and
c) wherein said at least one local electrical power generator further comprises at least one renewable energy generator structured and arranged to generate electrical power using at least one other-than-human renewable energy source; and
d) wherein said exercise facility is structured and arranged so that such locally generated electrical power is usable to assist in powering said exercise facility.

33) The exercise facility according to claim 32 wherein said exercise facility is certified by at least one locally-recognized environmentally-friendly building code.

34) The exercise facility according to claim 33 wherein such at least one locally-recognized environmentally-friendly building code comprises LEED Green Building Rating System.

35) The exercise facility according to claim 32 wherein such at least one other-than-human renewable energy source comprises solar energy.

36) The exercise facility according to claim 32 wherein such at least one other-than-human renewable energy source comprises wind energy.

37) The exercise facility according to claim 32 wherein such at least one other-than-human renewable energy source comprises geothermal energy.

38) The exercise facility according to claim 32 wherein such at least one other-than-human renewable energy source comprises tidal energy.

39) The exercise facility according to claim 32 wherein such at least one other-than-human renewable energy source comprises hydroelectric energy.

40) The exercise facility according to claim 32 further comprising at least one local storage device structured and arranged to store electrical power, when such generated electrical power exceeds such used generated electrical power.

41) The exercise facility according to claim 40 wherein said at least one local storage device comprises at least one battery.

42) The exercise facility according to claim 40 wherein said at least one local storage device comprises at least one hydrogen energy storage system.

43) The exercise facility according to claim 42 wherein said at least one hydrogen energy storage system comprises:
a) at least one hydrogen gas disassociator structured and arranged to disassociate hydrogen gas from water; and
b) at least one hydrogen gas storer structured and arranged to store such disassociated hydrogen gas.

44) The exercise facility according to claim 43 wherein said at least one hydrogen gas disassociator comprises at least one electrolysis chamber.

45) The exercise facility according to claim 43 wherein said at least one hydrogen gas storer comprises at least one hydrogen storage tank.

46) The exercise facility according to claim 43 wherein said at least one hydrogen energy storage system further comprises at least one electrical power retriever structured and arranged to retrieve such stored electrical power from such hydrogen gas.

47) The exercise facility according to claim 46 wherein said at least one electrical power retriever comprises at least one hydrogen fuel cell.

48) A method comprising the steps of:
a) franchising at least one environmentally-friendly fitness center business method;
b) wherein such at least one environmentally-friendly fitness center business method comprises the step of operating at least one exercise facility;
c) wherein such at least one environmentally-friendly fitness center business method further comprises
i) at least one carbon-credit monetizing method; and
ii) at least one environmentally-friendly power monetizing method;
d) wherein such at least one carbon-credit monetizing method comprises the steps of
i) purposefully instituting at least one carbon-footprint reduction method;
ii) obtaining at least one carbon credit due to such step of purposefully instituting at least one carbon-footprint reduction method; and
iii) monetizing such at least one carbon credit through at least one carbon-credit aggregator; and
e) wherein such at least one environmentally-friendly power monetizing method comprises the steps of
i) generating electrical power locally at such at least one exercise facility;
and selling such generated electrical power to at least one electrical utility company.

49) The method according to claim 48 further comprising the step of:
using such generated electrical power to assist in powering such at least one exercise facility; wherein such step of generating electrical power comprises the steps of converting human kinetic energy into electrical power and generating electrical power using at least one other-than-human renewable energy source.

50) The method according to claim 49 wherein such at least one other-than-human renewable energy source comprises solar energy.

51) The method according to claim 49 wherein such at least one other-than-human renewable energy source comprises wind energy.

52) The method according to claim 49 wherein such at least one other-than-human renewable energy source comprises geothermal energy.

53) The method according to claim 49 wherein such at least one other-than-human renewable energy source comprises tidal energy.

54) The method according to claim 49 wherein such at least one other-than-human renewable energy source comprises hydroelectric energy.

55) The method according to claim 49 wherein such at least one carbon-footprint reduction method comprises planting and maintaining vegetation.

56) The method according to claim 49 wherein such at least one carbon-footprint reduction method comprises recycling.

57) The method according to claim 56 wherein such at least one carbon-footprint reduction method comprises recycling grey water.

58) The method according to claim 56 wherein such at least one carbon-footprint reduction method comprises recycling rain water.

59) The method according to claim 49 wherein such at least one carbon-footprint reduction method comprises the step of reducing electrical energy consumption.

60) The method according to claim 59 wherein such step of reducing electrical energy consumption comprises the step of using solar energy to heat water for use in at least one swimming pool.

61) The method according to claim 59 wherein such step of reducing electrical energy consumption comprises the step of using solar energy to heat water for use as hot tap water.

62) The method according to claim 59 wherein such step of reducing electrical energy consumption comprises the step of using natural lighting.

63) The method according to claim 59 wherein such step of reducing electrical energy consumption comprises the step of using energy-efficient lighting.

64) The method according to claim 59 wherein such step of reducing electrical energy consumption comprises the step of using additional insulation to reduce atmospheric-temperature-control electrical energy consumption.

65) The method according to claim 64 wherein such additional insulation comprises recycled materials.

66) The method according to claim 49 wherein such at least one carbon-footprint reduction method comprises the step of using at least one atmospheric contaminant reduction method.

67) The method according to claim 66 wherein the step of using at least one atmospheric contaminant reduction method comprises the step of using electrostatic air filtration.

68) The method according to claim 66 wherein the step of using at least one atmospheric contaminant reduction method comprises the step of using at least one low-emission paint.

69) The method according to claim 49 wherein such at least one carbon-footprint reduction method comprises the step of complying with at least one locally-recognized environmentally-friendly building code.

70) The method according to claim 49 wherein such at least one locally-recognized environmentally-friendly building code comprises LEED Green Building Rating System.

71) The method according to claim 49 further comprising the step of storing such generated electrical power in at least one local storage device when such generated electrical power exceeds such used generated electrical power.

72) The method according to claim 71 wherein such at least one local storage device comprises at least one battery.

73) The method according to claim 71 wherein such at least one local storage device comprises at least one hydrogen energy storage method.

74) The method according to claim 73 wherein such at least one hydrogen energy storage method comprises the steps of:
a) disassociating hydrogen gas in water in at least one electrolysis chamber; and
b) storing disassociated hydrogen gas in at least one hydrogen storage tank.

75) The method according to claim 74 further comprising the step of retrieving such stored electrical power using at least one hydrogen fuel cell.

76) An exercise facility comprising:
a) local electrical power generator means for generating electrical power locally at said exercise facility;
b) wherein said local electrical power generator means comprises human kinetic energy converter means for converting human kinetic energy into electrical power; and
c) wherein said local electrical power generator means further comprises renewable energy generator means for generating electrical power using at least one other-than-human renewable energy source; and
d) exercise-facility electrical power user means for using such generated electrical power to assist in powering said exercise facility.

77) Each and every novel feature, element, combination, step and/or method disclosed or suggested by this provisional patent application.
